(19) United States
(12) Patent Application Publication
(10) Pub. No.: US 2025/0302030 A1
(43) Pub. Date: Oct. 2, 2025

(54) Bird Effigy

(71) Applicant: Russell S. Adams, Port Orange, FL (US)

(72) Inventor: Russell S. Adams, Port Orange, FL (US)

(21) Appl. No.: 19/239,896

(22) Filed: Jun. 16, 2025

Related U.S. Application Data
(63) Continuation-in-part of application No. 18/371,741, filed on Sep. 22, 2023, now Pat. No. 12,329,145.
Application No. 18/371,741 is a continuation of application No. 17/833,793, filed on Jun. 6, 2022, now Pat. No. 11,766,037.
Application No. 17/833,793 is a continuation-in-part of application No. 16/906,212, filed on Jun. 19, 2020, now Pat. No. 11,350,623.
Application No. 16/906,212 is a division of application No. 16/420,894, filed on May 23, 2019, now Pat. No. 10,701,927.
Application No. 16/420,894 is a continuation-in-part of application No. 15/989,121, filed on May 24, 2018, now abandoned.
(60) Provisional application No. 62/510,486, filed on May 24, 2017.

(51) Int. Cl. A01M 29/06; A01M 29/32

(52) U.S. Cl. CPC A01M 29/06; A01M 29/32

(57) ABSTRACT

Systems, devices, apparatus and methods for deterring birds and other animals from cell towers, communications towers, buildings, and other areas. An effigy, such as a broken wing effigy, of the species to be deterred can be suspended with upper and lower suspending structures. The effigy body and wings can be molded or otherwise formed from rubber, plastic, or any other suitable material. A hanger, such as a C-shaped hanger, an A-shaped hanger, or another hanger can be attached to a support structure, such as a tower, building, or other structure. The hanger allows the effigy to move in simulation of an actual bird, whether alive, lifeless, or in distress. Linkages between the hanger and the bird effigy and between the main body of the effigy and a wing of the effigy allow for unhindered, realistic movement of the bird effigy.

### CROSS REFERENCE TO RELATED APPLICATIONS

This application is a Continuation-in-Part of application Ser. No. 18/371,741, now U.S. Pat. No. 12,329,145, which is a Continuation of patent application Ser. No. 17/833,793, now U.S. Pat. No. 11,766,037, which is a Continuation-in-Part of patent application Ser. No. 16/906,212, filed Jun. 19, 2020, now U.S. Pat. No. 11,350,623, which is a Divisional of patent application Ser. No. 16/420,894, filed May 23, 2019, now U.S. Pat. No. 10,701,927, which is a Continuation-in-Part of patent application Ser. No. 15/989,121, filed May 24, 2018, now abandoned, which claims the benefit of priority to Provisional Application No. 62/510,486, filed May 24, 2017. The entire disclosures of each of the applications listed in this paragraph are incorporated herein by specific reference thereto.

### FIELD OF THE INVENTION

The present invention relates to deterring birds and animals, and in particular to systems, devices, apparatuses, and methods for deterring birds and other creatures from areas and structures, such as but not limited to buildings and cell and other communication towers, with bird effigies. The bird effigies disclosed herein are adapted to keep birds, such as vultures including turkey vultures and black vultures, eagles, osprey, owls, turkey vultures, and/or birds of prey, from congregating in an area where one of their own species has been injured or killed. The invention is particularly useful to protect areas or structures that are susceptible to damage from birds, such as, for example, buildings, masts, or radio towers such as cell telephone towers or beacon towers, which rely on antennas and sensitive electronics. By keeping birds and other animals from congregating in such areas, damage from the birds, their talons, and their droppings can be prevented.

### BACKGROUND OF THE INVENTION

Over the years, birds and other creatures have been known to cause billions of dollars in damage each year requiring ongoing maintenance and repairs as well as presenting health risks to the structures on which they congregate and their environs. Birds of prey, such as vultures, are known to roost on communication and broadcast towers as well as on the power and communication lines connected thereto. Defecations by roosting vultures have been known to interfere with the operation of expensive equipment and to create unsafe and unpleasant conditions for workers who climb the towers to service and install equipment. Furthermore, businesses and homeowners adjacent to vulture roosts can be adversely affected by vulture droppings and unpleasant odors.

Various types of deterrents have been attempted over the years including noise making devices, chemicals, and visual deterrents. However, using noisemakers and pyrotechnics are typically undesirable since they can be disruptive to neighboring businesses and homeowners and are fleeting in effect. Chemical deterrents are impractical because of the large perching areas and because they tend to interfere with operation and maintenance of the towers and to present dangers to workers as well as the neighboring public. Other deterrents, such as visual objects including reflecting tape and balloons, can be impractical to apply and are not effective with many types of birds and other creatures.

Research has shown that suspending carcasses of actual dead vultures proved to be a highly efficient method for controlling bird activity on or around the towers tested. Avery et al., Dispersing Vulture Roosts on Communication Towers, J. Raptor Res. 36(1), pages 45-50 2002. However, securing and suspending actual dead vulture carcasses from communication towers and other structure is not practical in all applications and does not provide a long-term solution. Suspending carcasses introduces a bio-hazard. Furthermore, real carcasses inevitably rot and decay. They are not long lasting. Further still, to procure carcasses in commercially feasible quantities, large number of birds would necessarily need to be killed and suspended in place. Such treatment of live animals may be considered to be inhumane.

It thus became apparent to the present inventor that there is a substantial need for an effective, long-lasting deterrent to birds and other nuisance creatures relative to cell and other communication towers and other structures.

### SUMMARY OF THE INVENTION

A primary objective of the present invention is to provide systems, devices, apparatus and methods for deterring birds and other animals from structures such as but not limited to cell towers, communications towers, buildings and areas to be protected by suspending replica effigies of the birds to be deterred, with the effigies having broken wings.

A secondary objective of the present invention is to systems, devices, apparatus and methods for deterring birds and other animals from areas to be protected, by mounting moveable replica bird effigies with broken wings which can vibrate and/or oscillate in the wind that appear to mimic live birds that are struggling in place.

A third objective of the present invention is to systems, devices, apparatus and methods for deterring birds and other animals from areas to be protected, by mounting moveable replica bird effigies with broken wings which can pivot up and down and/or swivel that appear to mimic live birds that are struggling in place.

A fourth objective of the present invention is to systems, devices, apparatus and methods for deterring birds and other animals from areas to be protected, by mounting moveable replica bird effigies with broken wings having a plurality of rotation points that appear to mimic live birds that are struggling in place.

The present invention can include systems, devices, apparatus and methods that have one or more of the following features and/or steps, which alone or in any combination may comprise patentable subject matter.

The present invention overcomes the shortcomings of the prior art in that it helps reduce, and, in many cases, eliminate, the hazards and damage associated, for example, with bird droppings by helping to eliminate the primary cause of these droppings--the birds themselves. It is desired to keep such unwanted birds from collecting in, on or near a subject structure.

When the systems, devices, apparatus and methods of the present invention are employed, for example, in cell and communication tower applications, the unwanted birds can become agitated and confused, and quickly migrate to another property or structure that presents a less threatening sight picture.

To an approaching bird, the effigy with broken wings of the invention looks life-like or lifeless depending upon the effigy, often creating a confused and agitated state in the approaching unwanted birds. These agitated and confused emotions are easily transferred bird-to-bird exponentially creating confusion among an approaching flock, and thereby causing the flocks to move on to another location. In this manner the effigy, and its manner of use, cause the deterring of unwanted birds from the subject structure.

The broken wing effigies of the present invention can be molded from any material such as plastic, resin or rubber materials or compounds, or can be fabricated from any other material and by any other means in the art, and thus eliminates the inhumane treatment of animals and the potential biohazards associated with handling dead carcasses.

Use of the systems, devices, apparatus and methods of the invention to deter birds from entering subject areas or structures is a humane approach to unwanted bird deterrence. Other methods of deterring unwanted birds or other animals, such as the use of firearms, explosives, loud noises or other means can be harmful to the birds and may present a danger to the users themselves.

Subject structures such as cellular telephone or communication towers using the apparatus and method of the invention can thus safely and effectively keep unwanted birds or other animals from causing damage to such subject structures. Towers that are free of unwanted birds are not only safer to work upon and service, but the associated communications equipment suspended on or near these towers tend to have a longer in-service life as a result of being free from bird droppings and other damage cause by unwanted birds or other animals.

The effigy internal structure may be molded in place within the effigy so as to provide a supporting structure for hanging the effigy. Non-limiting examples of exemplary effigy internal structures are depicted in the figures of the drawings.

The effigy can represent any bird with broken wing or animal with broken wing, including any animal that is desired to be deterred, and is typically, but not necessarily, an effigy of a dead animal of the species desired to be deterred.

The present systems, devices, apparatus and methods of the invention overcome the shortcomings of the prior art by providing, in an embodiment, a system and method for disposing a bird effigy in a position such that it appears to be dead and thus has a repelling effect on unwanted birds. In an embodiment, the effigy may be suspended from a structure in a head down orientation.

Another embodiment can include a hanger system with a moving bird effigy replica with broken wing, for deterring birds, that can comprise a hanger bracket having an upper end and a lower end, a bird effigy supported in the hanger bracket between the upper end and the lower end, and a mount mechanism for attaching the hanger bracket to a support structure, wherein the bird effigy is movable within the hanger bracket.

The hanger bracket can include a C-shaped bracket, with the upper end being an upper exposed end of the C-shaped bracket, and the lower end being a lower exposed end of the C-shaped bracket.

The moveable mechanism can include an armature plate imbedded in the bird effigy. The moveable mechanism can include a rotating member for allowing the bird effigy to rotate relative to the ledge on the post. The rotating member can include bearings for allowing one member to rotate relative to another member.

A broken wing embodiment can include a bird body separately molded about a bird armature plate, and a wing separately molded about a wing armature plate.

A method of making a moveable bird effigy, can include the steps of providing molds having a shape of a bird body effigy and bird wing effigy, inserting armature plates in separate mold, injecting or pouring a curable material, such as but not limited to resin, and the like, into the mold, curing the resin and armature plates together to form the bird effigy body and the bird wing effigy part, mounting the cured bird body effigy and bird wing part on a support structure, and moving the cured bird effigy relative to the support structure.

Certain embodiments of the invention can be characterized as a bird effigy assembly founded on a bird effigy for being suspended from a support structure. The bird effigy comprises at least one armature and a main body and left and right wings formed to encase the at least one armature at least partially. The main body and the left and right wings are simulative of the main body and left and right wings of a bird. A hanging linkage is configured for suspending the bird effigy from the support structure. The hanging linkage has a lower end coupled to the at least one armature of the bird effigy and an upper end portion configured to be coupled to the support structure. The hanging linkage has at least one linkage connection that permits rotation of the at least one armature about a longitudinal axis of the hanging linkage, and the hanging linkage has at least one linkage connection that permits pivoting about at least one lateral pivot axis within the hanging linkage.

Embodiments of the bird effigy assembly further comprise a hanger for suspending the bird effigy from the support structure. For instance, the hanger can take the form of an A-shaped hanger with a base leg member for being affixed to the support structure, a retaining leg member disposed at an acute angle relative to the base leg member, and a support bracket fixed to a distal end of the retaining leg member.

In practices of the invention, the at least one linkage connection permits rotation of the at least one armature about a longitudinal axis of the hanging linkage comprises a swivel plate configured to be rotatably retained by the hanger. A swivel member can be fixed to rotate with the swivel plate, and the linkage connection that permits pivoting about at least one lateral pivot axis within the hanging linkage can comprise a central pivot member pivotally coupled to the swivel member to pivot about a laterally communicating first pivot axis. The linkage connection that permits pivoting about at least one lateral pivot axis can further comprise a lower pivot member pivotally coupled to the central pivot member to pivot about a laterally communicating second pivot axis. The laterally communicating first pivot axis can have a different orientation from the laterally communicating second pivot axis, such as by having the laterally communicating first pivot axis approximately orthogonal to the laterally communicating second pivot axis.

It is further disclosed herein that the central pivot member can be selectively adjustable in effective length. For example, the central pivot member can be constructed with opposed upper pivot plates disposed in a spaced, facing relationship and opposed lower pivot plates disposed in a spaced, facing relationship with the upper and lower pivot plates positioned rotated by 90 degrees relative to the lower pivot plates and with lower portions of the upper pivot plates adjustably overlapping with upper portions of the lower pivot plates. In certain manifestations of the invention, the upper pivot plates have channels therein, and the lower pivot plates have teeth that are configured to slide within the channels in the upper pivot plates. The teeth of the lower pivot plates can be adjusted in position by sliding within the channels in the upper pivot plates to adjust the effective length of the central pivot member.

According to the invention, the swivel member can be U shaped, and a first end portion of the central pivot member can be pivotally coupled to a base of the U shape of the swivel member. Further, the lower pivot member can have a central upper portion and a forked lower portion with the central upper portion of the lower pivot member pivotally coupled to the central pivot member. A base plate can be fixed to the forked lower portion of the lower pivot member to form the lower end of the hanging linkage that is coupled to the at least one armature of the bird effigy. Also as disclosed herein, the at least one armature can comprise a body armature plate and an elongate rod fixed to the body armature plate. The body armature plate is at least partially encased by the main body of the bird effigy. The elongate rod has a proximal end and a distal end, and the proximal end of the elongate rod is retained by the base plate fixed to the forked lower portion of the lower pivot member.

As shown and described herein, the bird effigy comprises a body armature, a wing armature, and a wing linkage configured to connect the wing armature to the body armature. In such embodiments, the wing linkage has at least one linkage connection that permits pivoting of the wing armature relative to the body armature. For instance, the wing linkage can have upper and lower pivoting linkage connections that permit pivoting of the wing armature relative to the body armature at first and second pivoting locations.

Further still, the wing linkage can have a first ball joint connector coupled to the body armature, a second ball joint connector coupled to the wing armature, and a swivel linkage interposed between the first and second ball joint connectors. More particularly, the swivel linkage can comprise first and second U-shaped swivel connectors. The first U-shaped swivel connector is pivotally coupled to the first ball joint connector, and the second U-shaped swivel connector is pivotally coupled to the second ball joint connector. Additionally, the first and second U-shaped swivel connectors are rotatably retained by a coupling member interposed between the first and second U-shaped swivel connectors whereby a double swivel linkage is formed by the first and second U-shaped swivel connectors and the coupling member.

Also as taught herein, where the main body is formed to encase the body armature at least partially and where one of the left and right wings is formed to encase the wing armature at least partially, a main body entrance pocket can be formed in the main body centered around the first ball joint connector while a wing entrance pocket is formed in the one of the left and right wings centered around the second ball joint connector. As such, the first and second ball joint connectors can be countersunk within the pockets to permit a close relationship between the main body and the one of the left and right wings.

In certain embodiments, the at least one armature comprises an armature plate with plural apertures through the armature plate. The material forming at least one of the main body, the left wing, and the right wing, which can be a curable material, is configured to pass through the plural apertures through the armature plate. Further, the armature plate can have at least one rigidifying bent edge disposed within the material forming the at least one of the main body, the left wing, and the right wing.

One will appreciate that the foregoing discussion broadly outlines the more important goals and features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

The present invention will be described and explained with additional specificity and detail through reference to the accompanying drawings, wherein:

FIG. 1 depicts a perspective view of the internal structure of an embodiment of the invention;

FIG. 2a depicts a perspective view of an embodiment of a bird effigy of the invention attached to cables;

FIG. 2b depicts a cut away view of an embodiment of a bird effigy of the invention attached to cables, showing the internal structure of the invention;

FIG. 3 depicts a perspective view of the curb filter of the invention after it has been inserted into a curb inlet;

FIG. 4a depicts a perspective view from the front and side of the curb filter of the invention;

FIG. 4b depicts a perspective view from the front and side of the curb filter of the invention;

FIG. 5 depicts an exemplary use of an effigy of the invention in which the effigy is suspended upside down in order to repel unwanted birds from alighting on a subject structure;

FIG. 6A is a perspective front view of another embodiment of a C-shaped hanger bracket with upside down suspended bird replica effigy;

FIG. 6B is a rear view of the C-shaped hanger bracket with upside down suspended bird replica effigy shown in FIG. 6A;

FIG. 6C is a front view of the C-shaped hanger bracket with upside down suspended bird replica effigy shown in FIG. 6A;

FIG. 7A is a perspective view of the C-shaped hanger bracket shown in FIG. 6A;

FIG. 7B is a front view of the C-shaped hanger bracket shown in FIG. 7A;

FIG. 7C is a left side view of the C-shaped hanger bracket shown in FIG. 7A;

FIG. 7D is a top view of the C-shaped hanger bracket shown in FIG. 7A;

FIG. 8A is a perspective front view of the support rod and wing armature plate used to support the suspended bird in the C-shaped bracket shown in FIG. 7A;

FIG. 8B is a front view of the support rod and wing armature plate of FIG. 8A;

FIG. 8C is a side view of the support rod and wing armature plate of FIG. 8A;

FIG. 8D is a top view of the support rod and wing armature plate of FIG. 8A;

FIG. 9A is a front perspective view of the support rod and armature plate of FIG. 8A mounted in the suspended bird;

FIG. 9B is a front view of the support rod and armature plate of FIG. 8A mounted in the suspended bird of FIG. 9A;

FIG. 9C is a side view of the support rod and armature plate of FIG. 8A mounted in the suspended bird of FIG. 9A;

FIG. 10 is a perspective view of the C-shaped hanger bracket with mounted upside-down suspended bird replica effigy of FIGS. 6A-9C mounted to a cell/communications tower;

FIG. 11A is an enlarged front view of a prior art pipe to pipe clamp mount used to attach the C-shaped hanger bracket to the support leg on the cell/communications tower shown in FIG. 10;

FIG. 11B is a left side view of the pipe to pipe clamp mount of FIG. 11A;

FIG. 11C is a top view of the pipe to pipe clamp mount of FIG. 11A;

FIG. 12A is an upper front right side perspective view of a stand support for a moveable bird effigy replica embodiment;

FIG. 12B is a right side view of the stand support for a moveable bird effigy replica embodiment of FIG. 12A;

FIG. 12C is a left side view of the stand support for a moveable bird effigy replica embodiment of FIG. 12A;

FIG. 12D is a top view of the stand support for a moveable bird effigy replica embodiment of FIG. 12A;

FIG. 12E is a bottom view of the stand support for a moveable bird effigy replica embodiment of FIG. 12A;

FIG. 13A is another right side view of the stand support for a moveable bird effigy replica embodiment of FIG. 12A with the effigy facing to the right;

FIG. 13B is another right side view of the stand support for a moveable bird effigy replica embodiment of FIG. 13 with the effigy rotated ninety degrees;

FIG. 14A is a front head view of the stand support for a moveable bird effigy replica embodiment of FIG. 12A with effigy head raised;

FIG. 14B is a cross-sectional view of the stand support for a moveable bird effigy replica embodiment of FIG. 14A along arrows 14B;

FIG. 14C is a left side view of the stand support for a moveable bird effigy replica embodiment of FIG. 14B without the effigy;

FIG. 15A is another front head view of the stand support for a moveable bird effigy replica embodiment of FIG. 12A with effigy head lowered;

FIG. 15B is a cross-sectional view of the stand support for a moveable bird effigy replica embodiment of FIG. 15A along arrows 14B;

FIG. 15C is a left side view of the of the stand support for a moveable bird effigy replica embodiment of FIG. 14B without the effigy;

FIG. 16 is an enlarged exploded view of the components of the stand support for a moveable bird effigy replica embodiment referenced in the previous FIGURES without the effigy 400;

### Broken Wing Embodiments

FIG. 17A is a front perspective view of a broken wing effigy attached to a hanger mounted to a left support;

FIG. 17B is another front perspective view of a broken wing effigy attached to a hanger mounted to a left support;

FIG. 18A is a front perspective view of a broken wing effigy attached to a hanger mounted to a right support;

FIG. 18B another front perspective view of a broken wing effigy attached to a hanger mounted to a right support;

FIG. 19A is an upper front perspective view of the bird armature plate with hanging linkage connection, and the wing linkage connection with wing armature plate within the broken wing effigy of FIGS. 17A-18B;

FIG. 19B is another upper front perspective view of the bird armature plate with hanging linkage connection, and the wing linkage connection with wing armature plate within the broken wing effigy of FIGS. 17A-18B;

FIG. 19C is an upper rear perspective view of the bird armature plate with hanging linkage connection, and the wing linkage connection with wing armature plate within the broken wing effigy of FIGS. 17A-18B;

FIG. 19D is another upper rear perspective view of the bird armature plate with hanging linkage connection, and the wing linkage connection with wing armature plate within the broken wing effigy of FIGS. 17A-18B;

FIG. 19E is another front perspective view of FIG. 17A with the bird armature plate with hanging linkage connection, and the wing linkage connection with wing armature plate positioned adjacent the broken wing effigy attached to a hanger mounted to a left support;

FIG. 20A is a front view of the bird armature plate with hanging linkage connection, and the wing linkage connection with wing armature plate of FIGS. 19A-19B;

FIG. 20B is a rear view of the bird armature plate with hanging linkage connection, and the wing linkage connection with wing armature plate of FIGS. 19A-19B;

FIG. 20C is a left end view of the bird armature plate with hanging linkage connection, and the wing linkage connection with wing armature plate of FIGS. 20A-20B;

FIG. 20D is a right end view of the bird armature plate with hanging linkage connection, and the wing linkage connection with wing armature plate of FIGS. 20A-20B;

FIG. 20E is a top view of the bird armature plate with hanging linkage connection, and the wing linkage connection with wing armature plate of FIGS. 20A-20B;

FIG. 20F is a bottom view of the bird armature plate with hanging linkage connection, and the wing linkage connection with wing armature plate of FIGS. 20A-20B;

FIG. 21A is an upper front perspective view of the bird armature plate with threaded rod used in FIGS. 19A-20E;

FIG. 21B is an upper rear perspective view of the bird armature plate with threaded rod in FIG. 21A;

FIG. 21 C is a lower front perspective view of the bird armature plate with threaded rod in FIG. 21A;

FIG. 21 D is a lower rear perspective view of the bird armature plate with threaded rod in FIG. 21A;

FIG. 22A is an upper front perspective view of the wing armature plate with threaded rod used in FIGS. 19A-20E;

FIG. 22B is an upper rear perspective view of the wing armature plate with threaded rod in FIG. 22A;

FIG. 22C is a lower front perspective view of the wing armature plate with threaded rod in FIG. 22A;

FIG. 22D is a lower rear perspective view of the wing armature plate with threaded rod in FIG. 22A;

FIG. 23A is a perspective view of the hanging linkage connection between the hanger and the threaded rod connection point of the bird body part of the broken wing effigy of FIGS. 19A-19E;

FIG. 23B is an exploded view of the hanging linkage connection between the hanger and the threaded rod connection point of the bird body part of FIG. 23A;

FIG. 24A is a perspective view of the double swivel top linkage of FIGS. 23A-23B;

FIG. 24B is a front side view of the double swivel top linkage of FIG. 24A;

FIG. 24C is a top view of the double swivel top linkage of FIG. 24A;

FIG. 25A is an upper front perspective view of the anchor swivel linkage of FIGS. 23A-23B;

FIG. 25B is a lower front perspective view of the anchor swivel linkage of FIGS. 23A-23B;

FIG. 26A is a perspective view of the wing linkage connection between the threaded rod connection point of the bird body part with the threaded rod attached to the wing armature plate of FIGS. 19A-19E;

FIG. 26B is an exploded view of the wing linkage connection between the threaded rod connection point of the bird body part with the threaded rod attached to the wing armature plate of FIG. 26A;

FIG. 27A is an enlarged view showing the wing pocket in the wing part of the broken wing effigy for the wing linkage connection shown in FIGS. 17A-18B;

FIG. 27B is an enlarged view of the bird pocket in the bird part of the broken wing effigy for the wing linkage connection shown in FIGS. 17A-18B and 27A;

FIG. 28A is a perspective view of an alternative hanging linkage connection between the hanger and the threaded rod connection point of the bird body part of the broken wing effigy of FIGS. 19A-19E with chain links;

FIG. 28B is an exploded view of the alternative hanging linkage of FIG. 28A;

FIG. 29A is a perspective view of an alternative wing linkage connection between the threaded rod connection point of the bird body part with the threaded rod attached to the wing armature plate of FIGS. 19A-19E with single chain type link;

FIG. 29B is an exploded view of the alternative wing linkage of FIG. 29A;

FIG. 30A is a perspective assembled view of an alternative hanger to bird body connection;

FIG. 30B is an exploded perspective view of the alternative hanger to bird body connection of FIG. 30A;

FIG. 31A is a perspective assembled view of an alternative bird body to wing connection;

FIG. 31B is an exploded perspective view of the alternative bird body to wing connection of FIG. 31A;

FIG. 32 is a perspective cross-sectional view of the 7×7 cables used in the alternative connections shown in FIGS. 31A-31B;

FIG. 33 is a view in front elevation of a further alternative embodiment of the broken wing effigy as supported by a hanger;

FIG. 34 is a view in rear elevation of the broken wing effigy of FIG. 33 again as supported by a hanger;

FIG. 35 is a view in front elevation of the framework of the broken wing effigy as supported by a hanger without the molded body and wings of the effigy;

FIG. 36 is a perspective view of the framework of the broken wing effigy as supported by a hanger without the molded body and wings of the effigy;

FIG. 37 is an alternative perspective view of the framework of the broken wing effigy as supported by a hanger without the molded body and wings of the effigy;

FIG. 38 is an amplified perspective view of the upper connecting structure of the framework of the broken wing effigy as supported by a hanger;

FIG. 39 is an amplified perspective view of the wing-body connecting structure of the framework of the broken wing effigy;

FIG. 40 is a perspective view of the wing-body connecting structure of the framework of the broken wing effigy with the molded body and wings of the effigy in place depicting entry of the wing-body connecting structure into the molded body of the effigy; and

FIG. 41 is an alternative perspective view of the wing-body connecting structure of the framework of the broken wing effigy with the molded body and wings of the effigy in place depicting entry of the wing-body connecting structure into the molded wing of the effigy.

### DETAILED DESCRIPTION OF PREFERRED EMBODIMENTS

The bird effigy disclosed herein is subject to a wide variety of embodiments, each within the scope of the present invention. However, to ensure that one skilled in the art will be able to understand and, in appropriate cases, practice the invention disclosed herein, certain preferred embodiments of the broader invention are described below and shown in the accompanying drawing figures.

In the summary above, in this detailed description, and in the accompanying drawings, reference is made to particular features of the invention, including with respect to practicing the method disclosed herein. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

Certain embodiments of the bird effigy, sometimes alternatively embodied as a broken wing bird effigy, will be described more fully with reference to the accompanying drawings wherein preferred embodiments of the invention are shown. This invention may, however, be embodied in many different forms and should not be construed as limited to the embodiments set forth herein. Rather, these embodiments are provided so that this disclosure will be thorough and complete and will convey the scope of the invention to those skilled in the art. Like numbers refer to like elements throughout, and prime notation may be used to indicate similar elements in alternative embodiments.

Other technical advantages may become readily apparent to one of ordinary skill in the art after review of the present disclosure. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

As used herein, “effigy” includes within its meaning a replica of a dead bird or other animal of any species or a live bird or other animal or any species. Except as expressly limited by the claims, the effigy can be fabricated from any material, including but not limited to rubber, plastic, or any other material or combination thereof. The effigy is preferably, but not necessarily, a three dimensional effigy having an outer surface in the three-dimensional shape of a live or dead bird or another animal.

In an embodiment, the invention can comprise a bird-shaped effigy comprising an internal support structure for supporting the features of the effigy, such as wings, and for suspending the effigy from an external support structure. In further embodiments, the bird-shaped effigy may further comprise an internal support structure that is attached either directly or indirectly to a support cable. The support cable can be attached to the external support structure for suspending the effigy from the external support structure. In still further embodiments, the internal support structure may include attachments to a first cable for attaching to an upper suspending structure and a second cable for attaching to a lower suspending structure. Either or both of the first or second cables, can incorporate components for tensioning the cable or cables.

In still further embodiments, the bird-shaped effigy is further defined as having a plurality of wings. A plurality of supporting elements can be provided, such as one or more supporting elements for each wing of the bird-shaped effigy. The internal support structure may be further defined as being completely contained internally in the shaped effigy. The effigy may further be defined as providing the appearance of a dead bird. The effigy may further be defined as representing a specific species of animal or bird including, for example, a turkey buzzard, vulture, eagle, osprey, hawk or other species.

The following reference numerals are used herein:
1 Internal support structure central element
2 elongate rod
3, 4 supporting elements
5 connectors
6 plurality of holes
9 first cable
10 optional connection rod
11 connector
12 second cable
13 plate
14 bracket
15 threaded rod
16 optional cable tightening feature
100 effigy
101 subject structure
102 unwanted bird
103 upper suspending structure
200 hanger bracket for suspending moveable effigy bird embodiment
210 C-shaped hanger bracket
211 top eye bolt
212 upper legs
214 back leg
216 lower legs
219 bottom eye bolt
220 elongated rod
222 upper hook
228 lower hook
230 chain
240 wing plate
242 top bent edge
244 side wings
245 slots
248 bottom bent edge
250 replica effigy bird (such as but not limited to a vulture)
260 pipe to pipe clamp mount
270 cell/communication tower
272 vertical support on tower 260
300 stand support for moveable bird effigy replica embodiment
310 vertical post
312 upper horizontal leg
320 ledge mounting armature plate
322 top plate portion
324 front bent edge
326 rear bent edge
330 bottom swivel mount base plate
335 bearings
338 upper swivel mount base plate
340 effigy base
348 effigy rudder
350 effigy support legs
360 effigy body armature plate
362 bent tip portion
363 support holes
364 wings
365 slots
366 bent wing edges
369 rear portion
370 effigy vertical support rods
371 inner side openings for axle 374
372 rocker arm
374 axle on bottom of rocker arm
376 upper pivot end
380 horizontal slider arms
382 effigy support axle
383 elongated inner end slots in slider arms 380
390 front support posts
392 lower pivot ends on front support posts
400 bird replica effigy
405 hollow inside portions of effigy 400

### Broken Wing Effigy Embodiments

500 broken wing effigy
502 body
504L left wing
504R right wing
505 hanger
506 base leg member
507 retaining leg member
508 brace member
509 support bracket
510 ball joint rod end with male part held by nut on hanger
515 anchors for support structure
520 bird armature plate
521 front end
522 flat bottom edge
523 convex curved top edge
524 oblong openings
525 rear end
526 vertical parallel openings
527 top bent edges in rear end
528 Bottom bent edges in rear end
529 slots between bent edges 527 and 528
530 threaded rod for bird armature plate
535 top ball joint rod end for threaded rod
545 bottom ball joint rod end for threaded rod
550 wing armature plate
551 front end
552 flat bottom edge
553 convex curved top edge
554 oblong openings
555 rear end
557 rear bent edge
558 bottom bent edge
559 slot between bent edges 557 and 558
560 threaded rod for wing armature plate
565 top ball joint rod end for threaded rod
566 retaining member
568 swivel plate
570 fastener
572 swivel member
574 pivot member
575 upper pivot plates
576 clevis pin
577 lower pivot plates
578 pivot member
580 clevis pin
582 fastener
584 base plate
600 hanging linkage connection with first plurality of linkages
610 ball joint male
612 bushings
615 cotter pin
617 clevis pin
620 double swivel linkage
621 clevis pin
621 cotter pin
622 top joint
624 bottom joint
630 anchor swivel linkage
632 anchor swivel top joint
634 anchor swivel mid joint
636 anchor swivel lower end
637 clevis pin
639 cotter pin
700 wing linkage connection with second plurality of linkages
715 clevis pin
717 cotter pin
719 bushings
720 double swivel linkage
721 coupling member
722 top joint
723 U-shaped swivel connector
724 bottom joint
725 clevis pin
727 cotter pin
729 bushings
770 bird body pocket
780 wing body pocket
800 alternative hanging linkage connection with chain links
810 top clevis shackle
815 top lock pin
820 chain links
830 bottom clevis shackle
835 bottom lock pin
900 alternative wing linkage connection with single chain type link
910 top clevis shackle
915 top lock pin
920 chain links
930 bottom clevis shackle
935 bottom lock pin
1100 alternative hanger to body connection with cable
1010 compression coupler with threaded end to hanger
1019 threaded socket in hanger
1020 7×7 stainless steel cable
1030 bottom compression coupler
1040 coupler with threaded socket end
1100 alternative body to wing connection with cable
1120 7×7 stainless steel cable
1130 coupler
1140 compression coupler with upper threaded end
1150 compression coupler with lower threaded end
1160 coupler with threaded socket ends

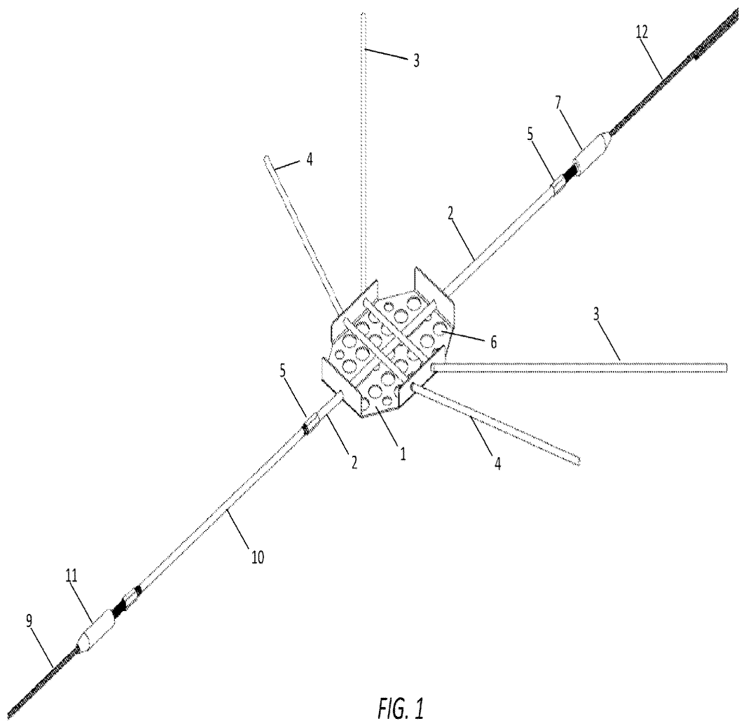

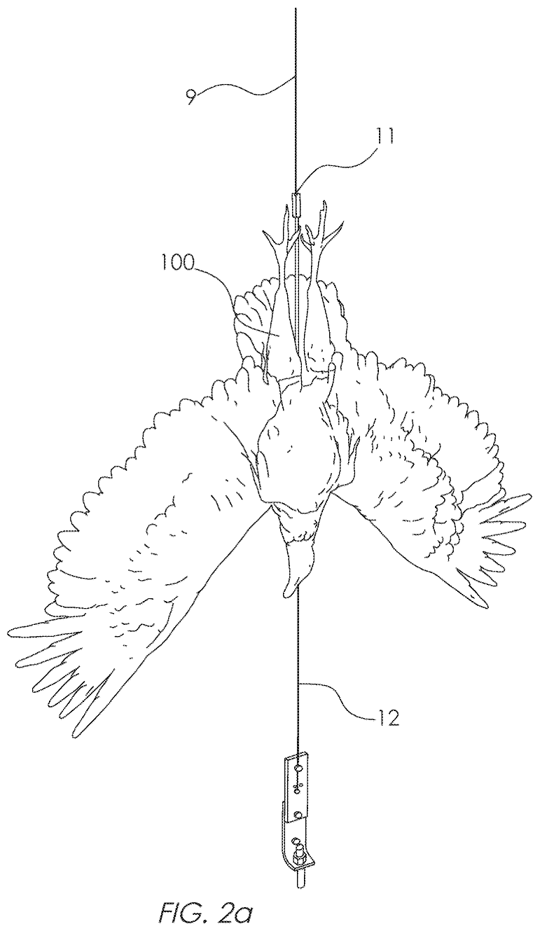

Referring now to FIG. 1, an embodiment of the internal support structure of the invention is depicted. The internal support structure may be utilized to provide structural support for the effigy as it is suspended from a subject structure to be protected, such as a cell or communication tower, or from a nearby structure. The internal support structure is founded on an internal support structure central element 1, which is attached to supporting elements 3 and 4. Supporting elements 3 and 4 are disposed to extend away from the internal support central element 1. Elongate rod 2 extends through the central element 1. The elongate rod 2 has distal and proximal ends that terminate in connectors 5 for attaching to a first cable 9 or a second cable 12, or both, or, alternatively.

One or more extension rods 10 can be interposed between the elongate rod 2 and the first and second cables 9 and 12. Connector 11 attaches cable 9 to extension rod 10. The use of the optional extension rod 10 allows for the adapting of the internal support structure to various sizes and shapes of birds.

The first and second cables 9 and 12 may be utilized to suspend the effigy from any structure, such as a tree, a communication equipment tower, a building structure, or any other structure relative to which it is desired to deter birds or other animals from approaching, nesting in, or alighting upon. For example, first cable 9 may attach to an upper suspending structure, and second cable 12 may attach to a lower suspending structure.

Internal support structure central element 1 is depicted in FIG. 1 as being fabricated from sheet metal with formed, bent side walls, but it will be understood that the central element 1 and each other component described herein can be fabricated from any suitable material and formed in any shape. The central element 1 is configured to provide sufficient strength to support the supporting elements 3 and 4 and rod 2. Thus, the internal support structure central element 1 can be welded, cast, molded, assembled from multiple components, and the central element 1 can be fabricated from composite materials, metal, plastics, or any other material, and the central element 1 can take any shape with sufficient strength to support the supporting elements 3 and 4 and the rod 2.

In certain alternate embodiments, such as where the internal support structure central element 1 is fabricated from a sheet material, it may include one or plural cutouts or holes 6 of given shapes to lighten the structure. In the exemplary embodiment depicted in FIG. 1, the internal support structure central element 1 comprises a plurality of holes 6.

In embodiments of the invention, an outer surface of the effigy 100 encloses the internal support central element 1 and the supporting elements 3 and 4. Thus, the internal support structure may comprise the internal support structure central element 1, supporting elements 3 and 4, the rod 2, and, optionally, the extension rod 10.

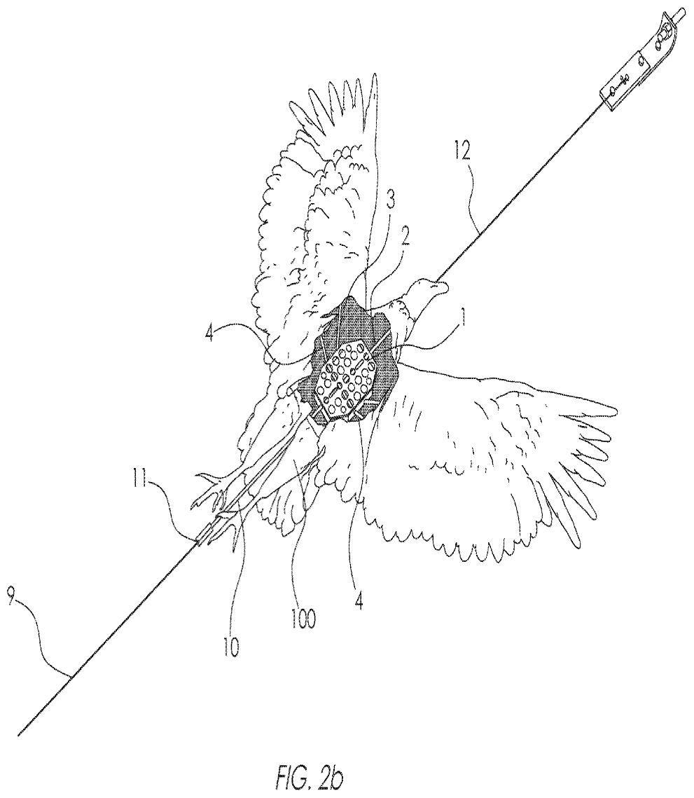

Referring now to FIG. 2a, an effigy 100 is depicted suspended from first cable 9 and second cable 12. The internal support structure is embedded within the effigy 100. In a typical application, the effigy 100 is suspended head downward, although such a disposition is not necessary. In a downwardly-oriented suspension, the first cable 9 is attached to an upper suspending structure such as a portion of a cell or communication tower, tree or other structure. The second cable 12 can be attached to a lower suspending structure and can comprise components for adjusting to provide tension in the cables 9 and 12 to keep the effigy 100 from swaying in the wind and causing damage to the itself or any surrounding structure. Connector 11 is shown for reference interposed between the effigy and the first cable 9 maintaining the head of the effigy 100 in the downward position.

Referring now to FIG. 2b, a partially cutaway view of effigy 100 is depicted thereby allowing the internal supporting structure to be seen. The internal support structure may be, but is not necessarily, embedded completely within the effigy 100. This can be accomplished, for example, by molding the internal support structure into the effigy 100 during the fabrication process. The internal support structure can be defined as the structure attached to in and internal to the effigy 100. It provides mounting points and supporting structure internal to the effigy 100. The internal support structure keep effigy portions, such as wings or other effigy features, from sagging, such as under the force of gravity, when the effigy 100 is suspended.

In this exemplary embodiment of the invention, the internal support structure can comprise internal support structure central element 1, supporting elements 3 and 4, and rod 2. In an exemplary process, the effigy 100 can be crafted by the creation of a mold for the effigy 100, placing the internal support structure within the mold, and molding the effigy around the internal support structure so that only cable 12 and extension rod 10 extend outside of molded effigy 100.

Extending supporting elements 3 and 4, which are attached to central element 1, extend into features of the effigy 100 such as the wing areas of the bird, providing support for each wing. In the example shown in FIG. 2b, it can be seen that the wings of the effigy 100 can, in some embodiments, represent a large amount of mass of the effigy 100, thus requiring internal support from extending elements 3 and 4.

Some effigies 100, such as smaller effigies 100, may not require extending support elements 3 or 4. Other effigies 100, such as larger effigies 100 representing larger species of birds or animals, may require at least one or a plurality of extending support elements 3 and 4 to support each of the features of the effigy 100, such as, for example, the wings. It is to be understood that the scope of the invention includes all sizes of birds and animals except as expressly limited by the claims. Other types of animals may be represented by effigies having particular structural needs. Thus, any number of extending support elements 3 or 4 may be included within the scope of the invention to support features of such effigies 100. The effigy 100 depicted in FIG. 2b, for instance, is but one example of many effigies 100 included within the scope of the invention.

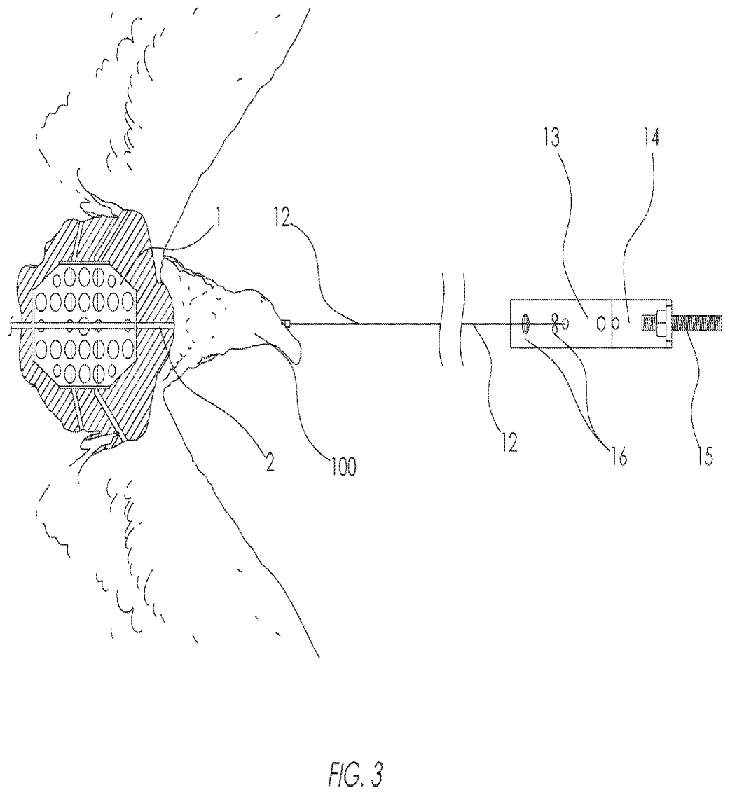

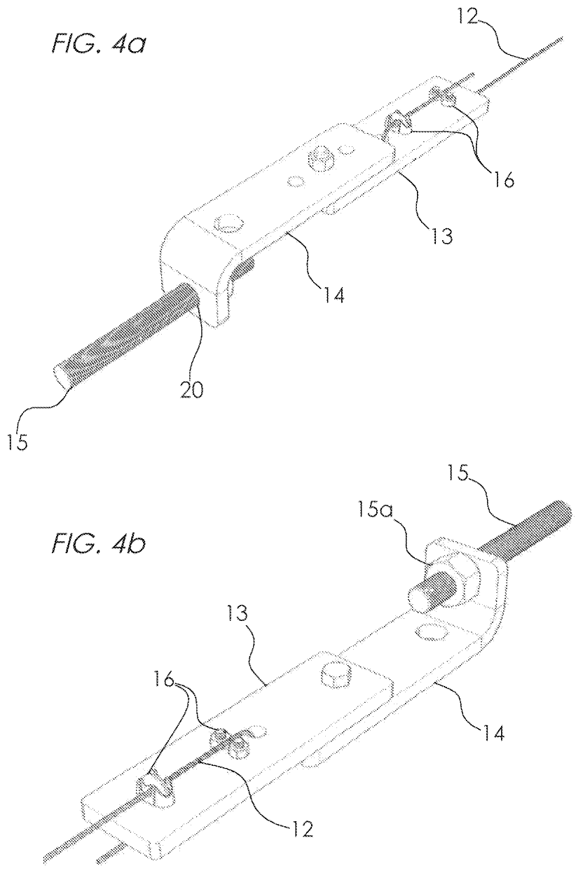

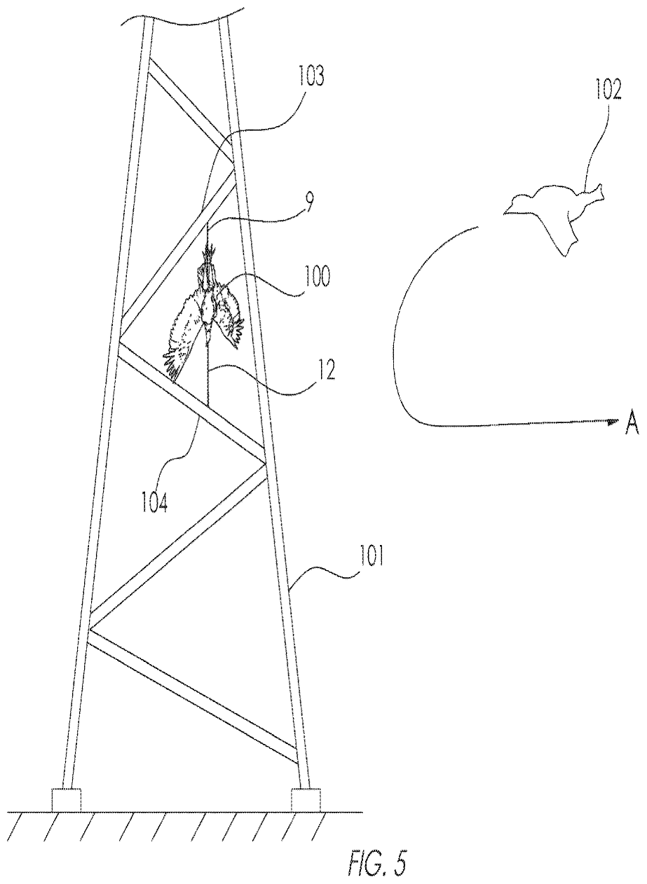

Referring now to FIG. 3, an embodiment of the effigy 100 is depicted again in cutaway view showing the internal central structure element 1 and rod 2. Cable 12, which is connected to rod 2 extends to an optional cable tightening mechanism comprising elements 13, 14, 15, and 16. These elements 13, 14, 15, and 16 are further depicted in greater detail in FIGS. 4a and 4b. There, it can be seen that the tension in cable 12 can be adjusted by the tensioning mechanism provided by use of at least one, and potentially a plurality of, cable clamp 16 mounted onto plate 13. Plate 13 may be bolted, welded or otherwise attached to an L bracket 14, which includes a threaded hole adapted to receive a threaded rod 15 in a threaded engagement. The threaded rod 15 can be tightened against the L bracket 14 by a tightening nut 15a. Using this feature of the invention, the effigy 100 can be suspended, and the cable 12 can be placed into tension such that the effigy 100, among other things, is prevented from swaying or swinging in the wind. Threaded rod 15 can be utilized to secure the effigy 100 to any structure. In this manner, an effigy 100 can be suspended and cables 12 and 9 can be placed into tension, safely securing the effigy 100 in place and preventing movement of the effigy 100 caused by forces generated by wind, rain, or other environmental forces.

Referring now to FIG. 5, an exemplary use of an effigy 100 according to the invention is illustrated where the effigy 100 is suspended upside down from a subject structure 101, such as a cell or communication tower, a tree, or any other subject structure 101, to repel unwanted birds from alighting on the subject structure 101. The effigy 100 can be an effigy of a dead bird, such as a dead vulture, turkey vulture, turkey, or any other fowl. A first end of first cable 9 is attached to an upper suspending structure 103, which may be a portion of a cell or communication tower, tree or other subject structure 101, and a second end of first cable 9 is attached to the optional extension rod 10 or rod 2 as hereinbefore described and depicted in FIG. 1. The second cable 12 is attached at a first end to a lower suspending structure 104. A tensioning mechanism, such as that depicted in FIGS. 4a and 4b, can comprise enable length adjustments, such to provide tension in the cables 9 and 12 to keep the effigy 100 from swaying in the wind and causing damage to itself or the subject structure 101.

In use, the effigy 100 is may be so retained with the purpose and effect of causing an agitated state in approaching unwanted birds 102. So agitated, the unwanted bird 102 can be caused to fly away from the subject structure 101 as depicted by arrow A. The present invention can thus be characterized further as a method for deterring birds or animals from an area, the method comprising the steps of: providing an effigy 100 comprising an internal supporting structure having a distal and proximate ends; providing a first cable 9 attached to the distal end and a second cable 12 attached to the proximate end; suspending the effigy 100 by attaching the first cable 9 to an upper suspending structure 103, and attaching the second cable 12 to a lower suspending structure 104; and tensioning either or both cables 9 and 12 to prevent the effigy from swaying, such as due to environmental conditions. The method may also be further defined in that the effigy 100 can be suspended in a head down disposition. The effigy 100 can be an effigy or replica of a live or dead animal. The effigy 100 can be shaped in the form of a buzzard, vulture, osprey, hawk or eagle, and/or other birds of prey, and other birds and the like.

In still further embodiments, the effigy 100 can be an effigy of a live bird or animal such as an eagle, osprey, hawk, or Coopers hawk. An effigy 100 of a living bird or other creature can be presented in a heads up or other orientation and can be supported by a structure that rotatably attaches the effigy 100 to a supporting structure thereby allowing the effigy 100 to rotate in such a manner approximating weathervanes in the wind, meaning that it rotates due to the force of the wind on its surfaces such that the effigy 100 either faces into or away from the wind direction. Such effigies 100 of live birds operate to present the appearance of a dominating territorial bird, which may repeal approaching unwanted birds 102. As an example, an effigy 100 of a live bald eagle may be used to repel, or deter, an osprey from approaching a subject structure 101 because the effigy 100 of the live bald eagle presents a dominating presence to the osprey. Ospreys will not generally nest under a bald eagle. However, it will again be understood that any of the effigies 100 described herein may take the form of a vulture, turkey vulture, black vulture, buzzard, osprey, eagle, hawk, owl, Coopers hawk, or perhaps another bird depending on the circumstances.

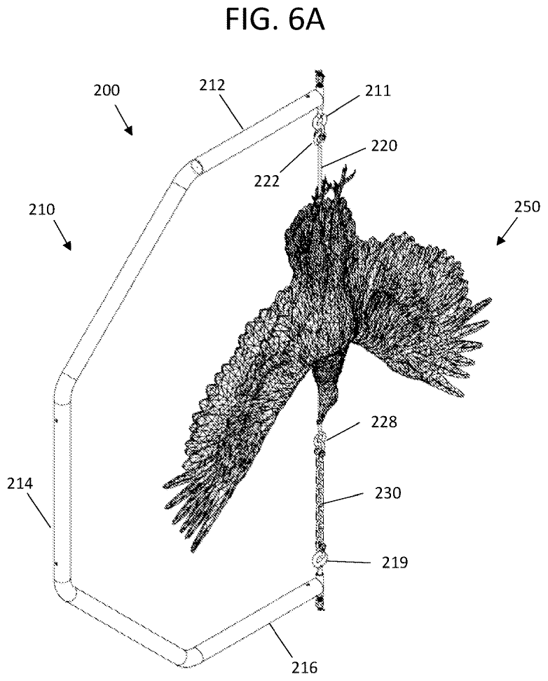

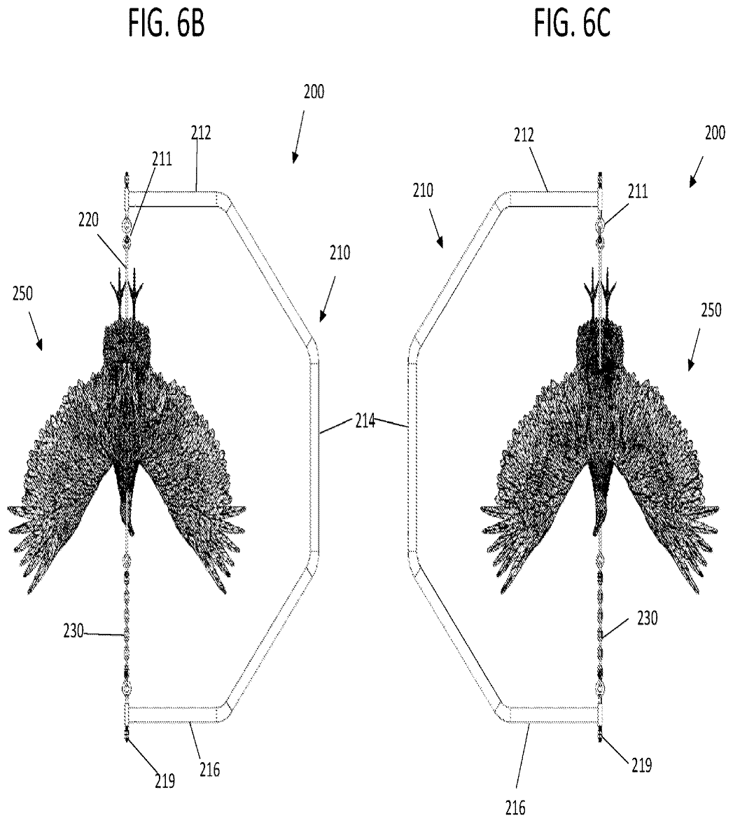

FIG. 6A is an anterior perspective view of an embodiment of a support structure 200 comprising a C-shaped hanger bracket 210 with an upside-down effigy 250 comprising a suspended bird replica. FIG. 6B is a posterior perspective view of the C-shaped hanger bracket 210 with the upside-down suspended bird replica effigy 250 of FIG. 6A. FIG. 6C is a front view of the C-shaped hanger bracket 210 with the upside-down suspended bird replica effigy 250 shown in FIG. 6A.

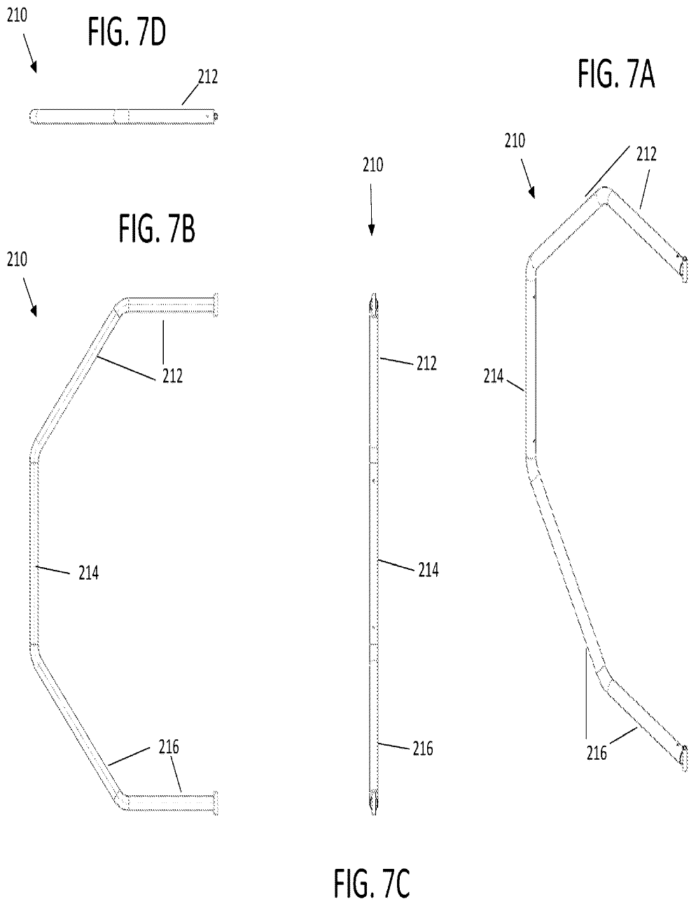

FIG. 7A is a perspective view of the C-shaped hanger bracket 210 shown in FIG. 6A. FIG. 7B is a front view of the C-shaped hanger bracket 210 shown in FIG. 7A. FIG. 7C is a left side view of the C-shaped hanger bracket 210 shown in FIG. 7A. FIG. 7D is a top view of the C-shaped hanger bracket 210 shown in FIG. 7A.

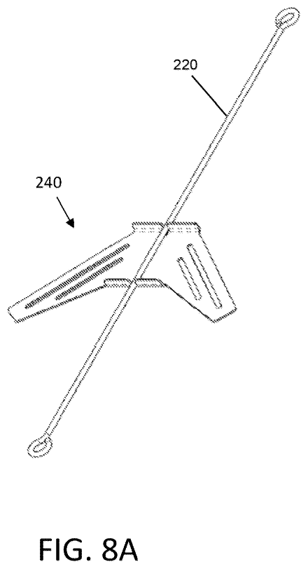

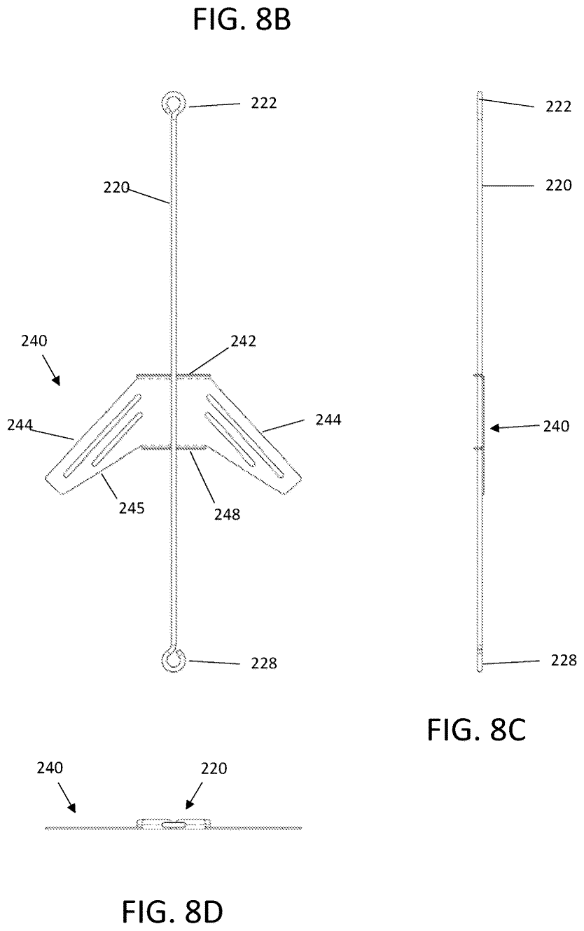

FIG. 8A is a perspective front view of an elongate support rod 220 and wing armature plate 240 used to support the suspended bird replica effigy 250 in the C-shaped bracket 210 shown in FIG. 7A. FIG. 8B is a front view of the elongate support rod 220 and wing armature plate 240 of FIG. 8A. FIG. 8C is a side view of the elongate support rod 220 and wing armature plate 240 of FIG. 8A. FIG. 8D is a top view of the elongate support rod 220 and wing armature plate 240 of FIG. 8A.

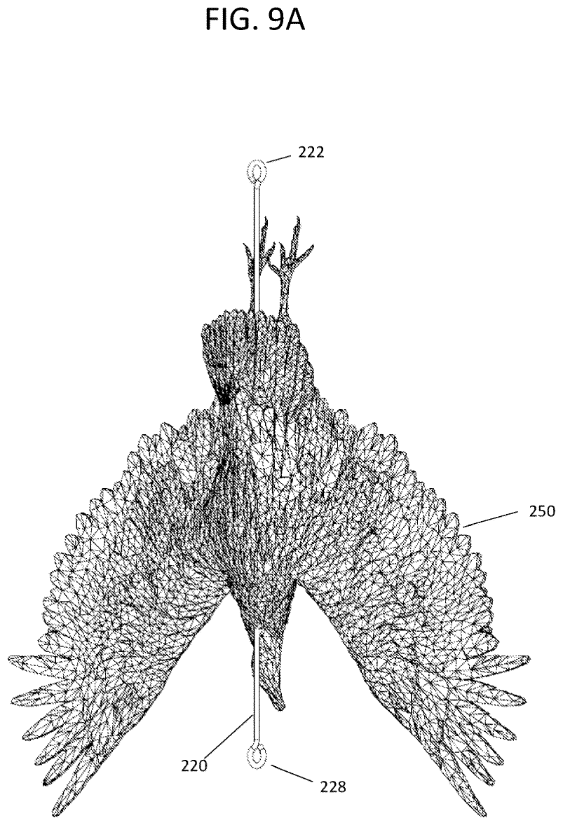

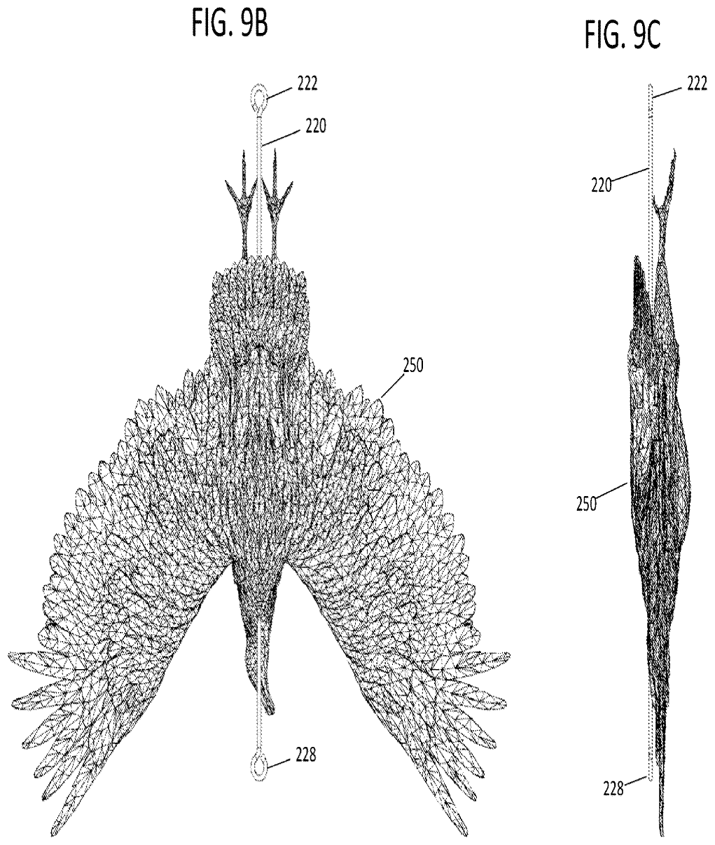

FIG. 9A is an anterior perspective view of the elongate support rod 220 and wing armature plate 240 of FIG. 8A mounted in the suspended bird replica effigy 250. FIG. 9B is an anterior view of the elongated support rod 220 and wing armature plate 240 of FIG. 8A mounted in the suspended bird replica effigy 250 of FIG. 9A. FIG. 9C is a side view of the elongated support rod 220 and wing armature plate 240 of FIG. 8A mounted in the suspended bird replica effigy 250 of FIG. 9A.

Referring to FIGS. 6A-9C, the C-shaped hanger bracket 210 can be formed from metal, such as but not limited to galvanized steel, stainless steel, or any other suitable material. The bracket 210 can be formed from one pipe bent into a C shape. Alternatively, the C-shaped bracket can be formed from straight pipe sections having upper legs 212 and back leg 214 and lower legs 216 that can be welded together or otherwise joined. The top outer end and bottom outer end of the bracket 210 can have through-holes to allow for a top eye bolt 211 and bottom eye bolt 219 to be mounted therein, such as by helical threads.

The elongate support rod 220 has an upper end with an upper hook 222 and a lower end with a lower hook 228. A wing-shaped armature plate 240 has a top bent edge 242 and bottom bent edge 248 with the edges having openings therethrough for allowing a mid-portion of the elongated support rod 220 to pass therethrough. The bent edges 242, 248 can be also attached to the mid portion of the rod 220 by welding or in any other method. The rod 220 and wing shaped armature plate 240 can be formed from metal, such as but not limited to galvanized steel or stainless steel, or any other appropriate material.

In one preferred embodiment, a mold having a shape of a bird effigy has the wing shaped armature plate 240 placed into the mold with the pre-attached elongate rod 220. The lower part of the elongate rod 220 can be intended to extend from a head portion of the bird replica effigy 250 with an upper part of the rod 220 extending out from a rear portion of the bird replica effigy 250. Curable material, such as but not limited to resin, plastic, or another material or combination thereof, can be injected into the mold. The material can cure about the wing plate 240 passing into the parallel slots 245, about the bent edges 242, 244, and about the side wings 244, which can partially extend into the wings of the bird replica effigy 250. The injected curable material locks to the wing plate 240 and elongate rod 220 upon curing. The lower part of the elongated rod 220 extends from a head portion of the bird replica effigy 250, and an upper part of the rod 220 extends out from a rear portion of the bird replica effigy 250.

For the final assembly, the upper hook 22 on the elongate rod 220 with upside-down bird replica effigy 250 is attached to the top eye bolt 211 attached to an upper leg 212 of the C-shaped bracket 210. The lower hook 228 on the bottom of the elongate rod 220 can be attached to one end of a chain 230. The opposite end of the chain 230 can be attached to a bottom eye bolt 219, which is attached to a lower leg 216 of the C-shaped bracket 210.

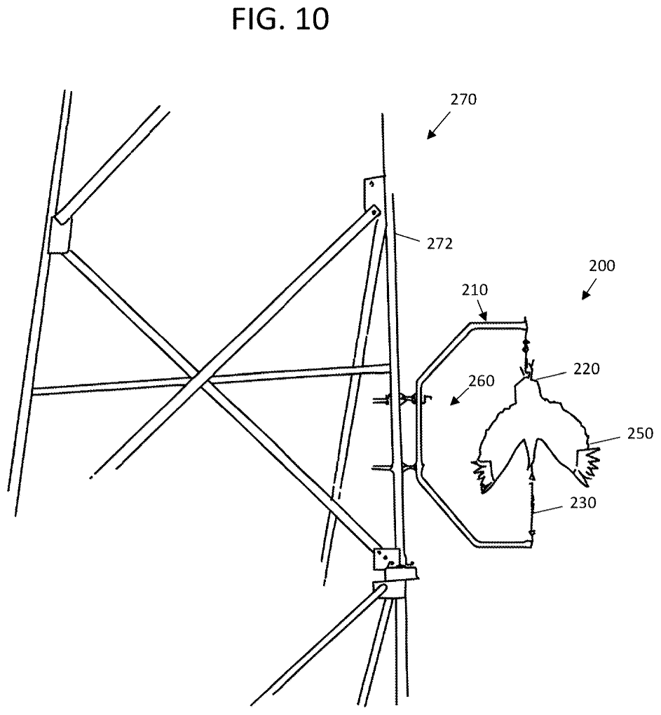

FIG. 10 is a perspective view of the C-shaped hanger bracket 210 with the mounted upside-down suspended bird replica effigy 250 of FIGS. 6A-9C mounted to a tower structure 270.

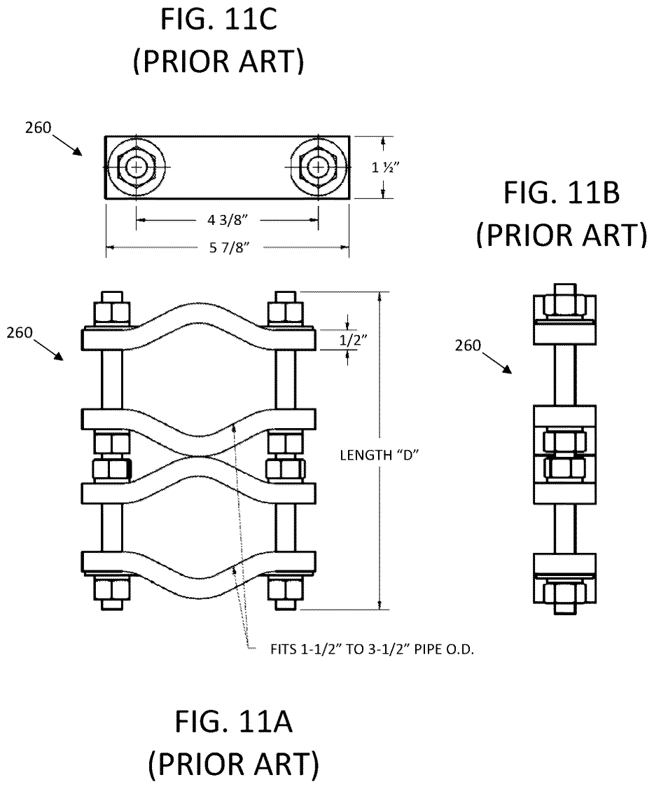

Referring to FIGS. 6A-10, the back leg 214 of the C-shaped bracket 210 is attached to a vertical support 272 on a cell or other communication tower 270 in any effective manner, such as but not limited to by clamps, such as a pipe-to-pipe clamp set 260 shown in FIGS. 11A, 11B, and 11C, or any other suitable mechanism.

When mounted, the bird replica effigy 250 may be somewhat loose based on the hooks 222, 228 and eye bolt fasteners 211, and chain 230 allowing the bird replica effigy 250 to move in place with vibrations and oscillations, such as in response to wind. The wing spans on the bird replica effigy 250 can also partially rotate relative to the C-shaped bracket 210. The movements of the upside down bird replica effigy 250 are designed to resemble to live birds a bird struggling in place, and this effect deters similar birds that are living from approaching the structure 270 to which the bird replica effigy 250 is mounted.

FIG. 11A is an enlarged front view of a prior art pipe-to-pipe clamp mount 260 that can be used to attach the C-shaped hanger bracket 200 to the support leg 272 on the cell or other communication tower 270 shown in FIG. 10. FIG. 11B is a left side view of the pipe-to-pipe clamp mount 260 of FIG. 11A. FIG. 11C is a top view of the pipe-to-pipe clamp mount 260 of FIG. 11A. As illustrated, the clamp mount 260 has two pairs of curved flange plates. One pair can be wrapped about the back leg 214 of the C-shaped bracket 210, and the other pair of curved flange plates can be wrapped about a vertical support 272 on the cell or other communications tower 270. Threaded rods with nuts that can thread thereon can thus attach the C-shaped hanger bracket 200 to the vertical tower 270.

In one embodiment, the C-shaped bracket 210 can have a height of approximately 69 inches and a width of approximately 40 inches. The bird replica effigy 250 can have a length of less than approximately 69 inches and a spread wing span of approximately 34 inches.

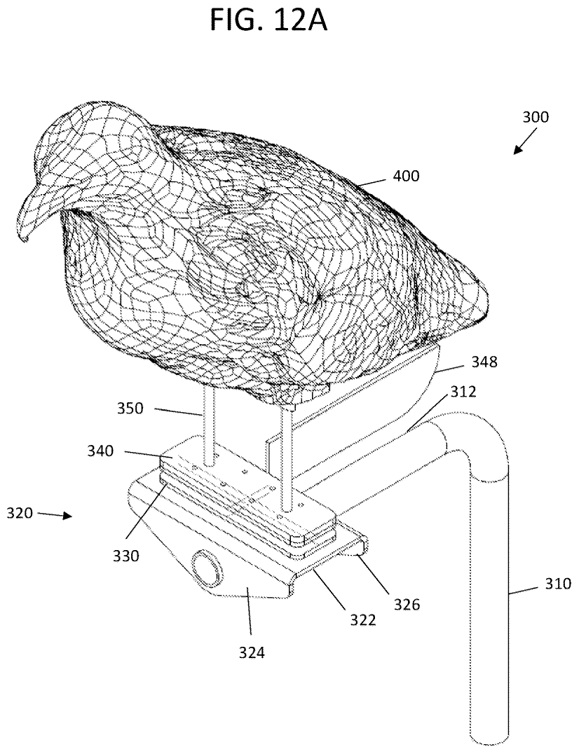

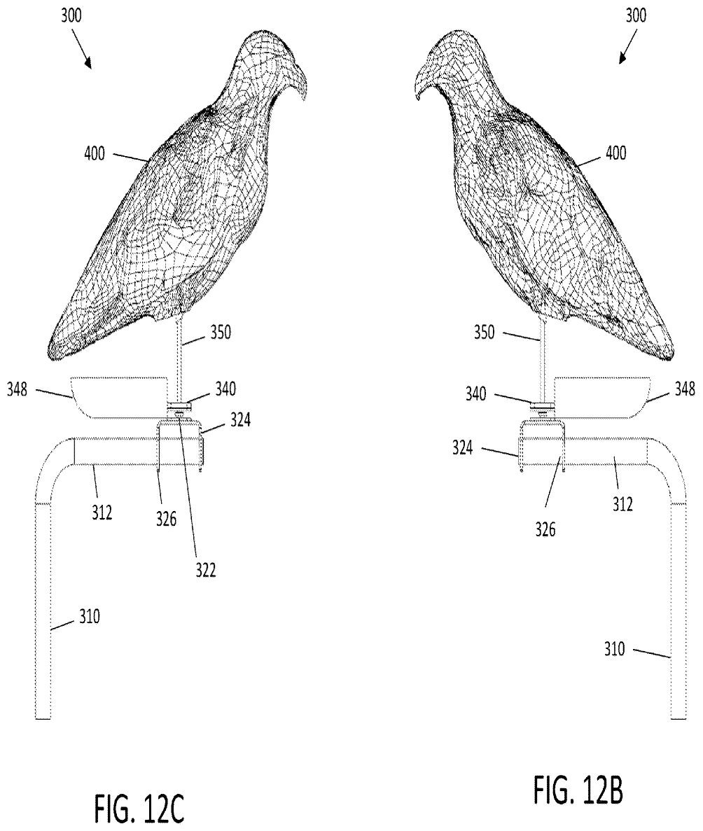

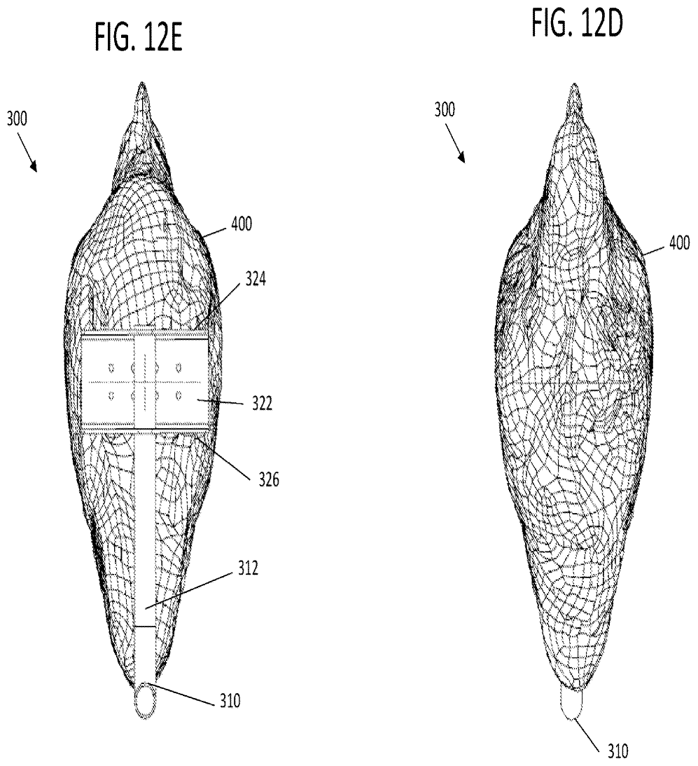

FIG. 12A is an upper front right side perspective view of a stand support 300 for a moveable bird effigy replica embodiment. FIG. 12B is a right side view of the stand support 300 for a moveable bird effigy replica embodiment of FIG. 12A. FIG. 12C is a left side view of the stand support 300 for a moveable bird effigy replica embodiment of FIG. 12A. FIG. 12D is a top view of the stand support 300 for a moveable bird effigy replica embodiment of FIG. 12A. FIG. 12E is a bottom view of the stand support 300 for a moveable bird effigy replica embodiment of FIG. 12A.

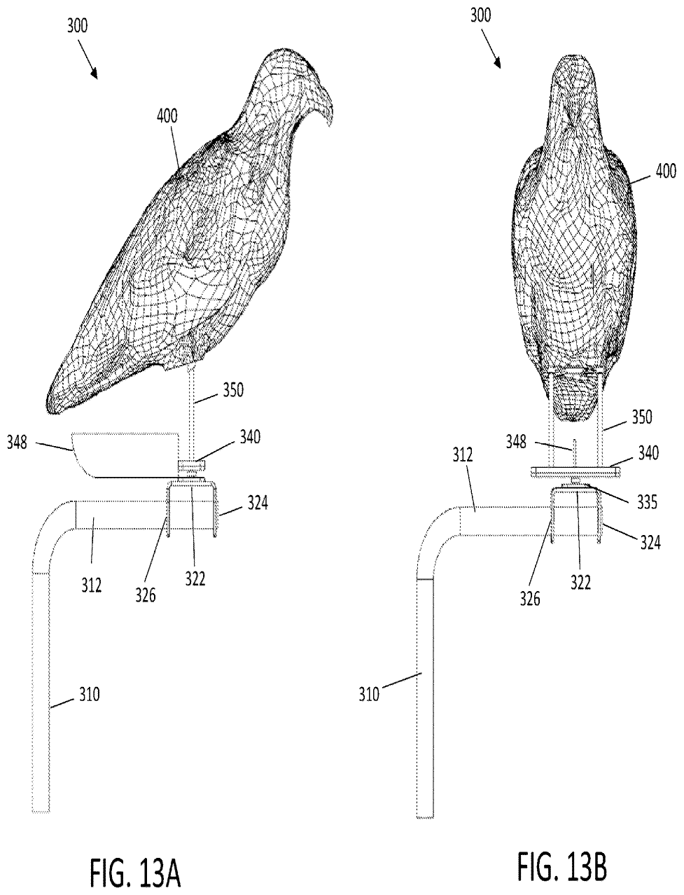

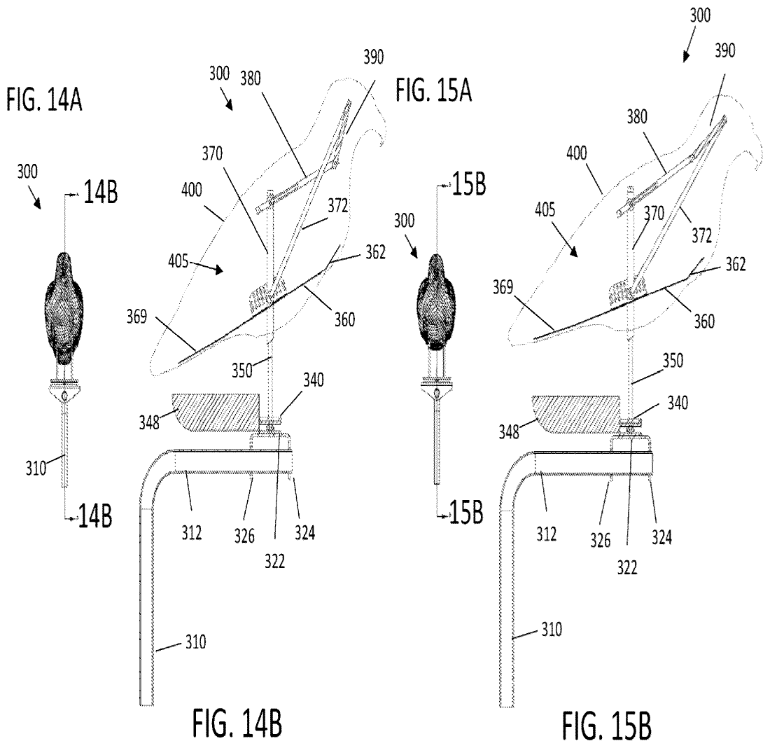

FIG. 13A is another right side view of the stand support 300 for a moveable bird effigy replica embodiment of FIG. 12A with the effigy 400 facing to the right. FIG. 13B is another right side view of the stand support 300 for a moveable bird effigy replica embodiment of FIG. 13 with the effigy 400 rotated ninety degrees.

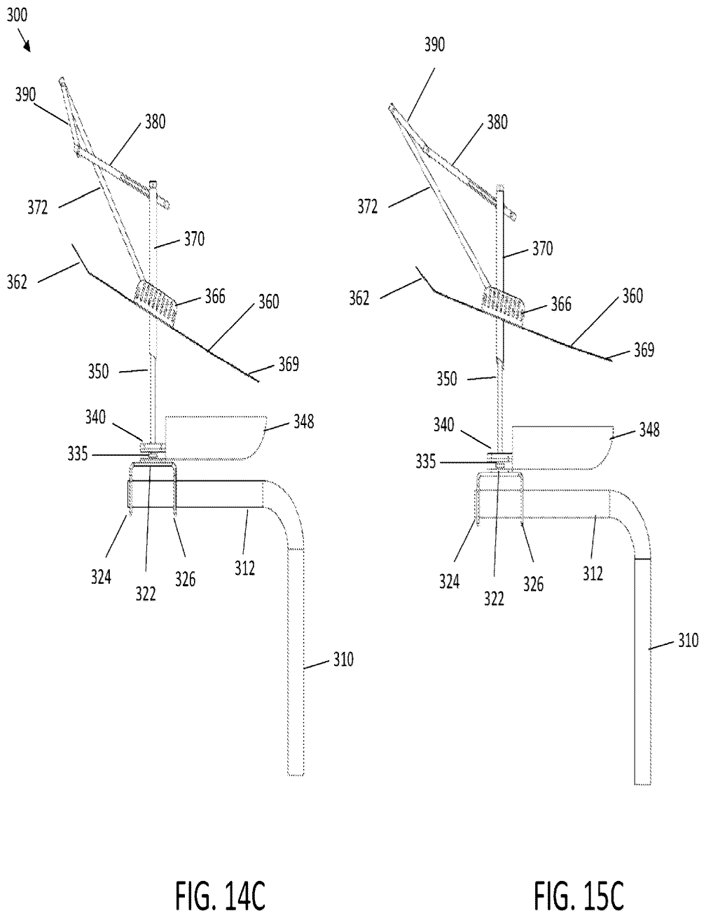

FIG. 14A is a front ahead view of the stand support 300 for a moveable bird effigy replica embodiment of FIG. 12A with the effigy 400 head end raised. FIG. 14B is a cross-sectional view of the stand support 300 for a moveable bird effigy replica embodiment of FIG. 14A taken along line 14B-14B. FIG. 14C is a left side view of the stand support 300 for a moveable bird effigy replica embodiment of FIG. 14B without the effigy 400.

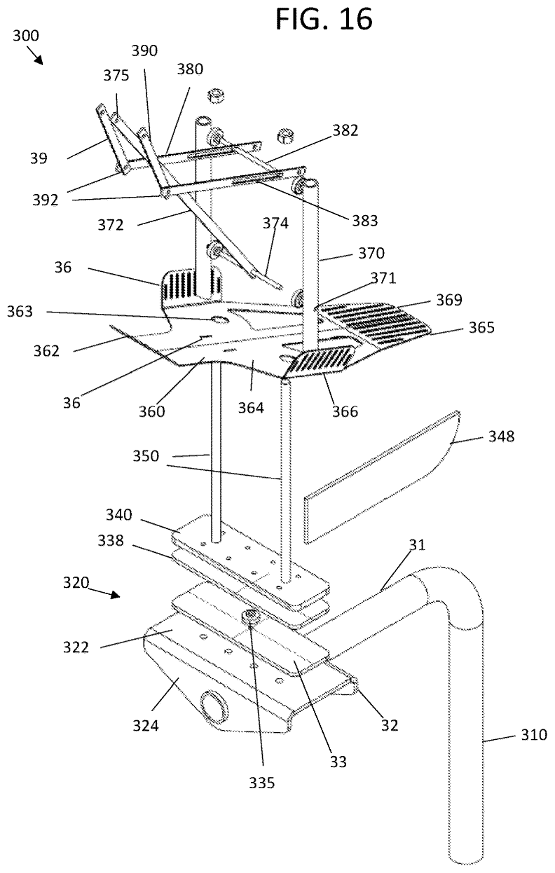

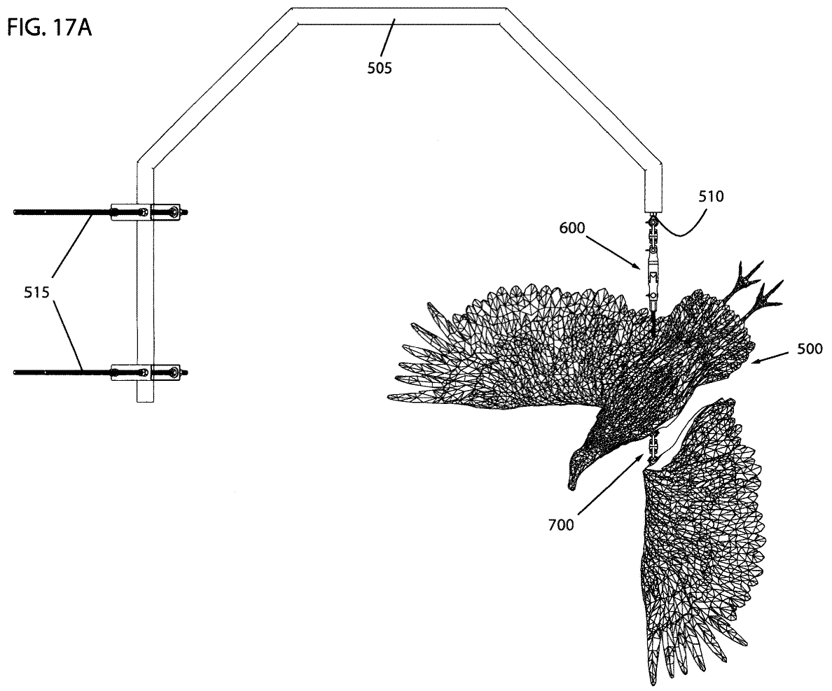

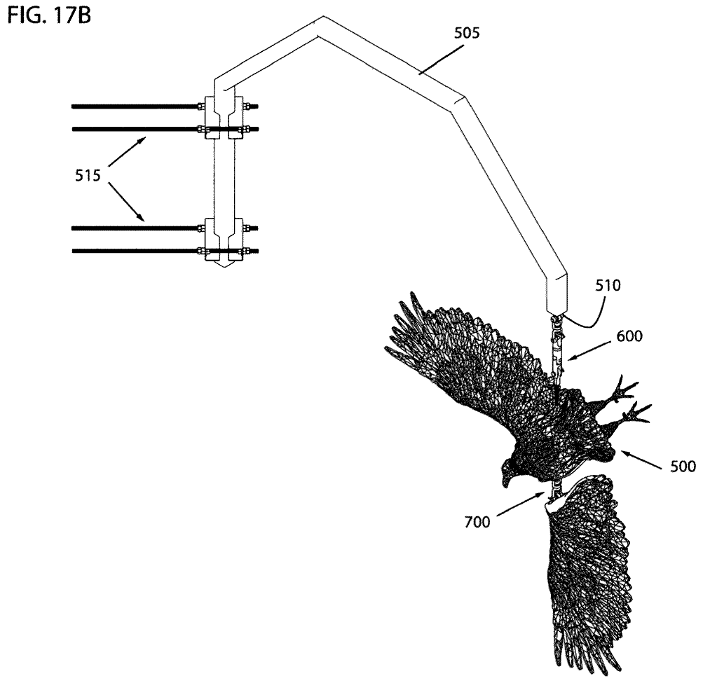

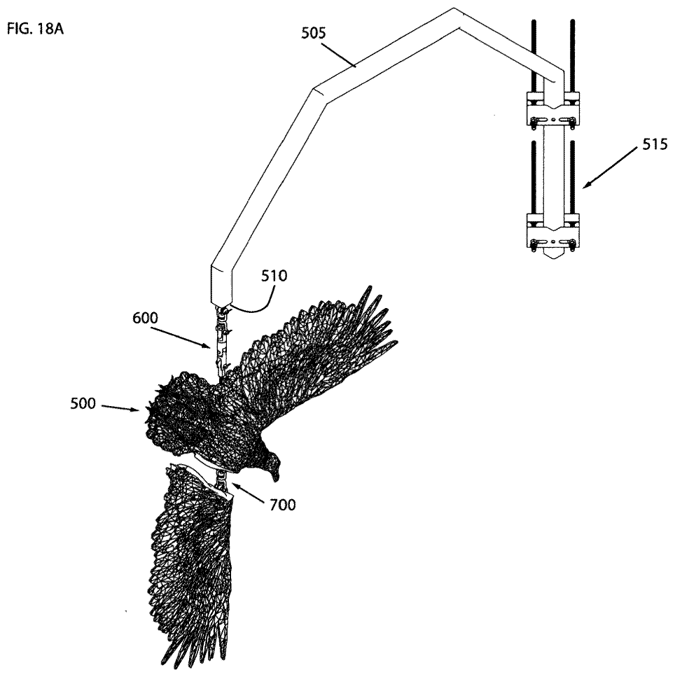

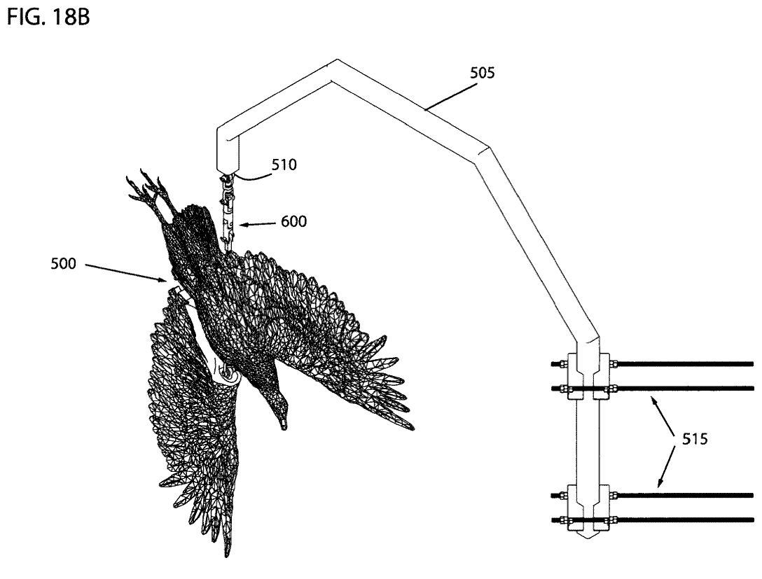

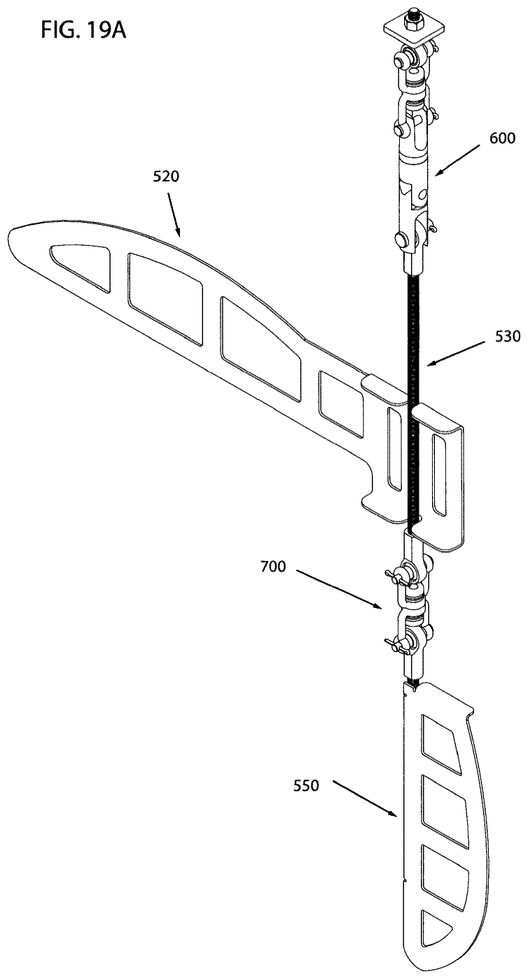

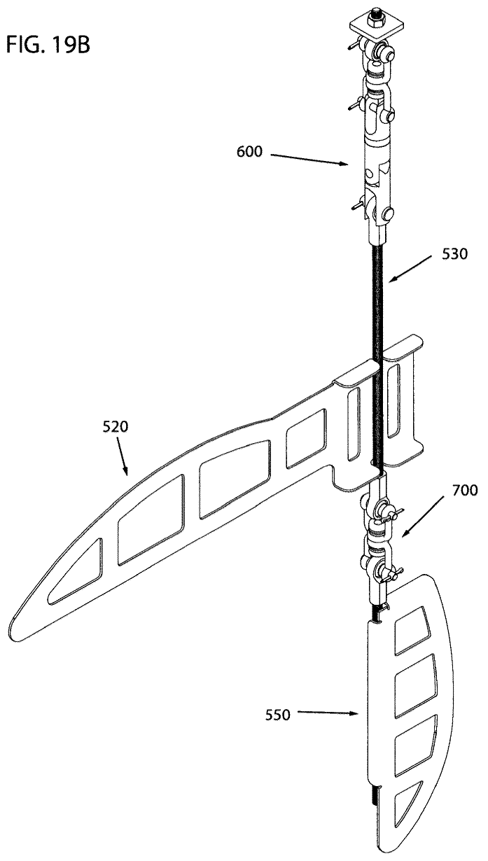

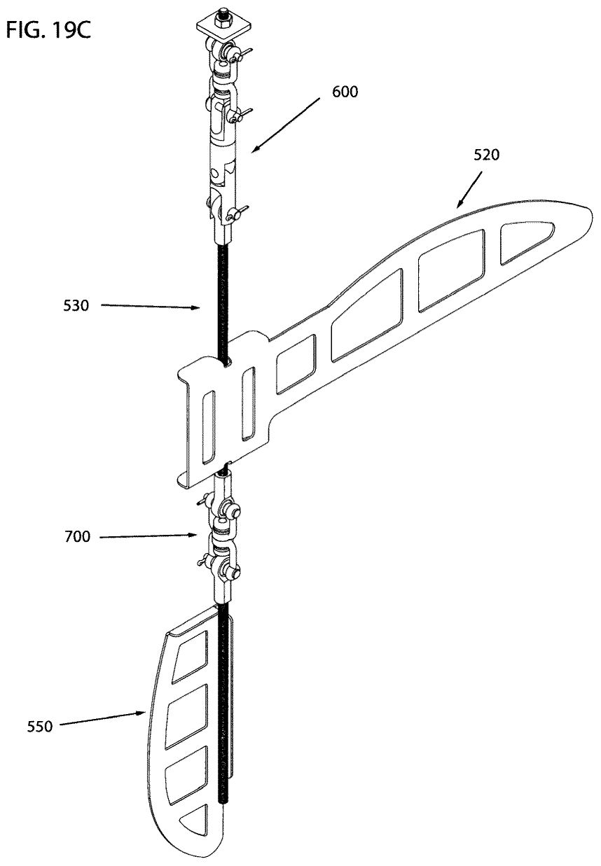

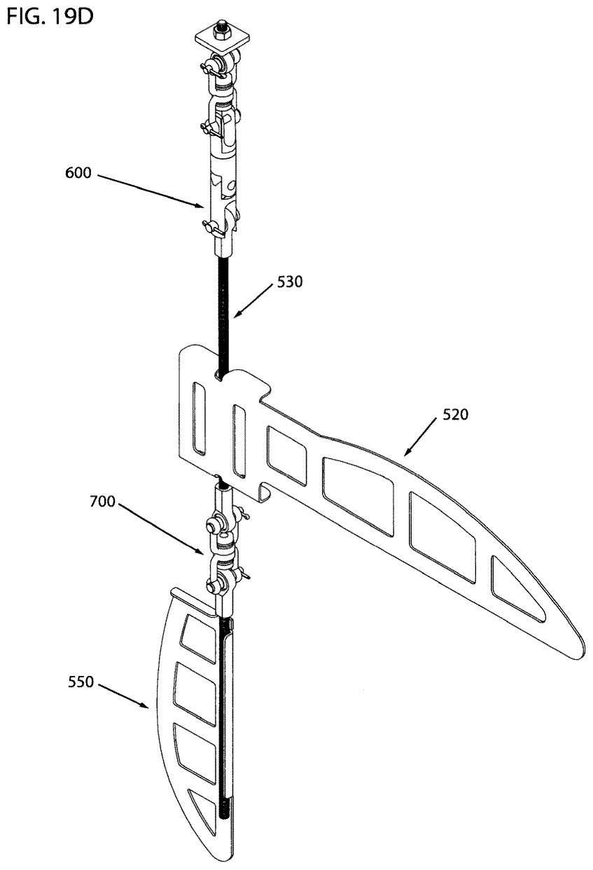

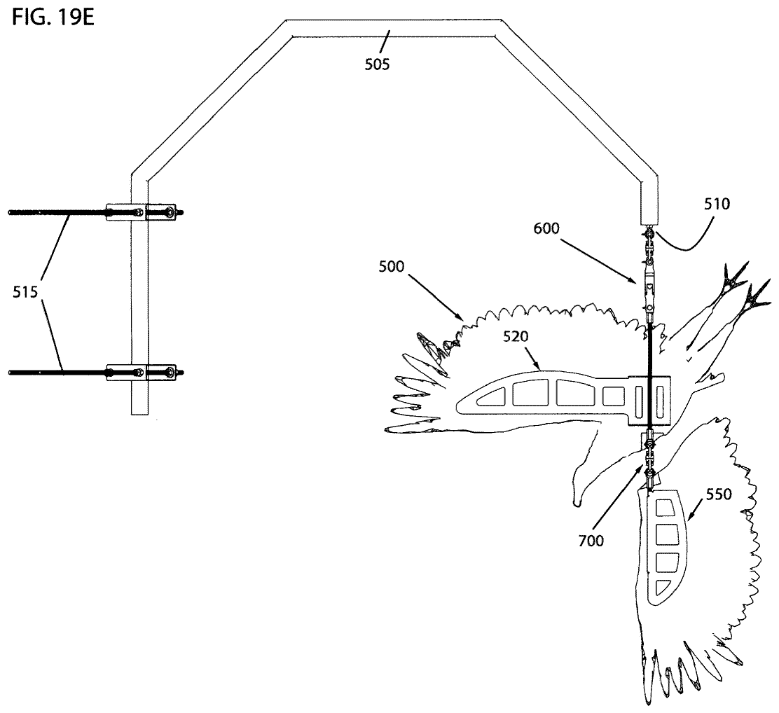

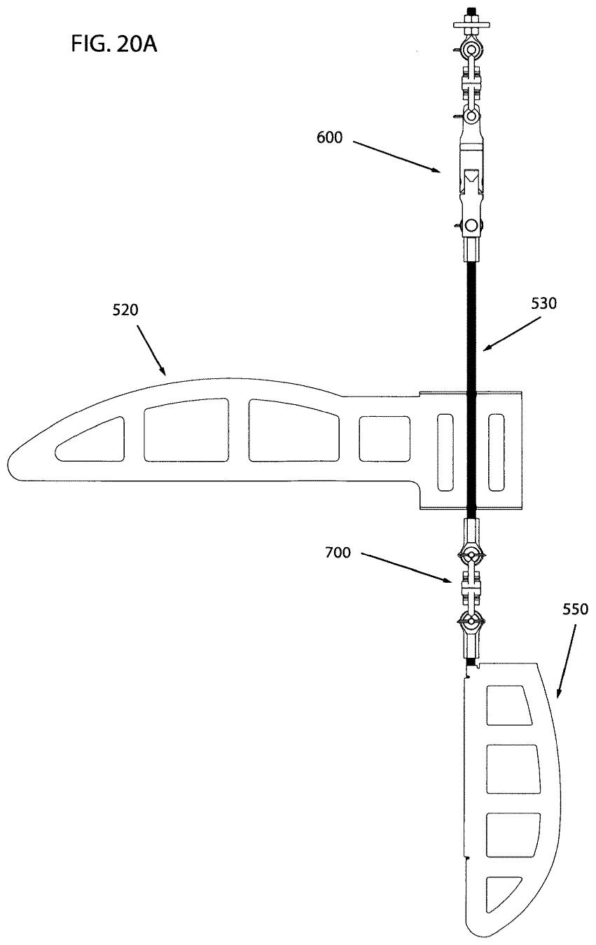

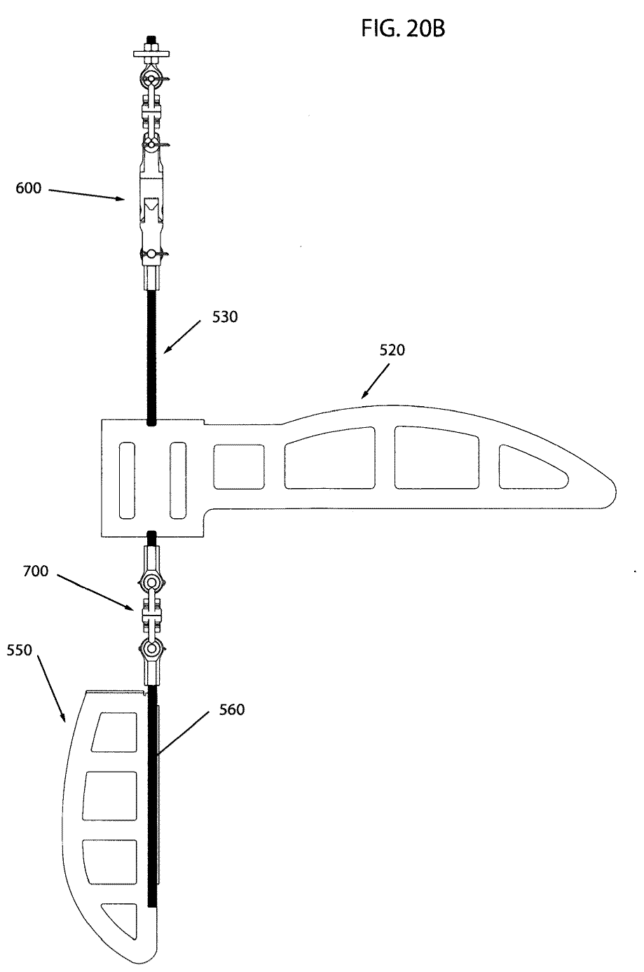

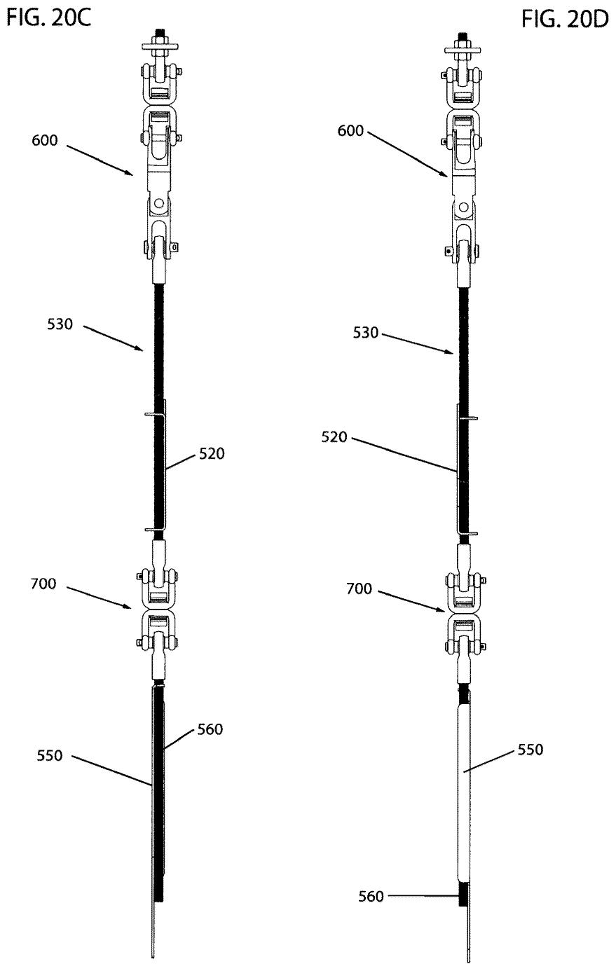

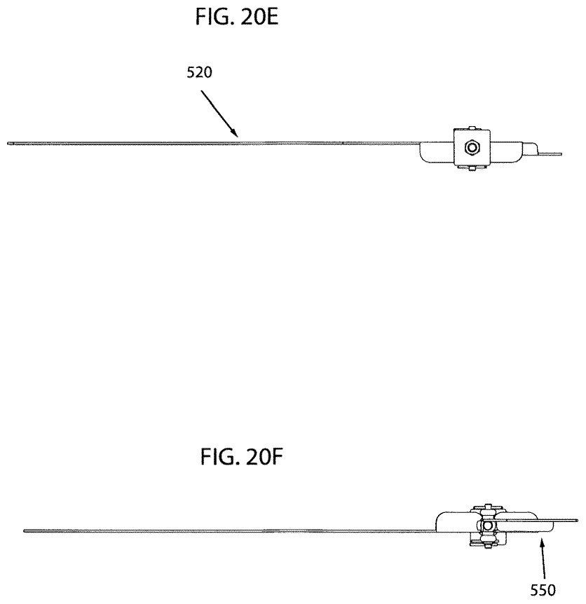

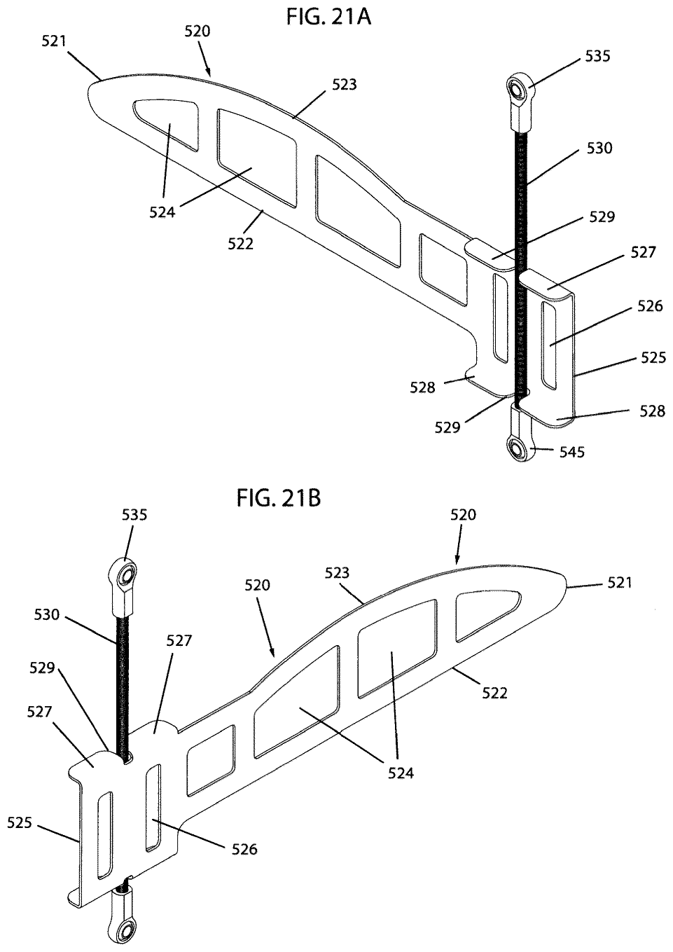

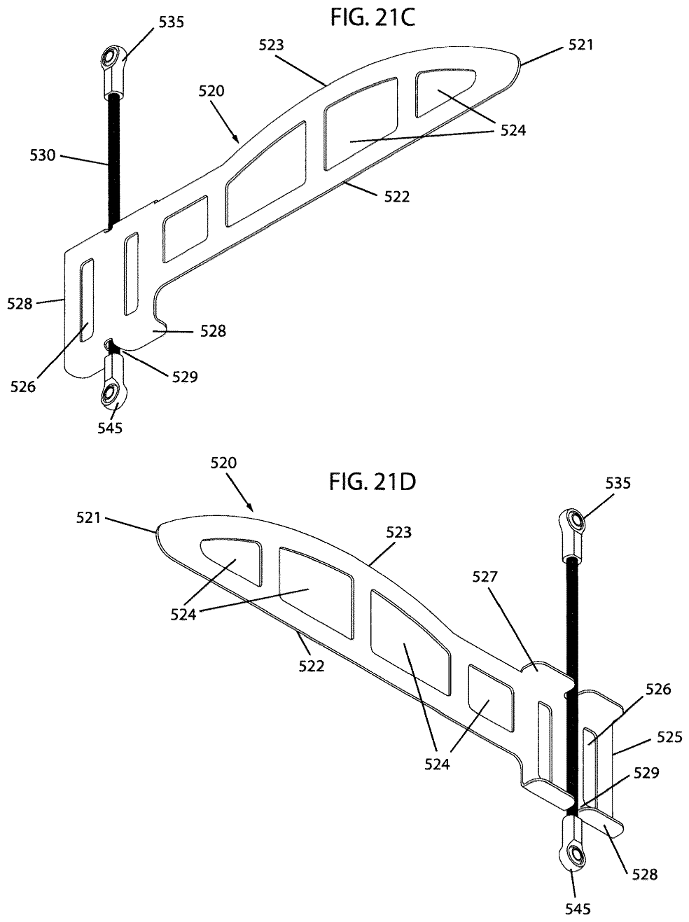

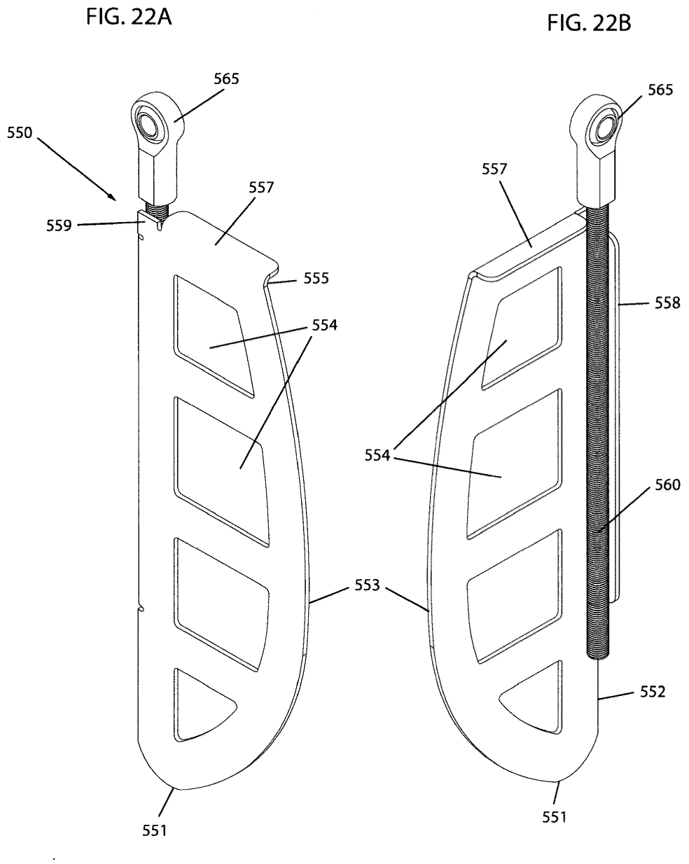

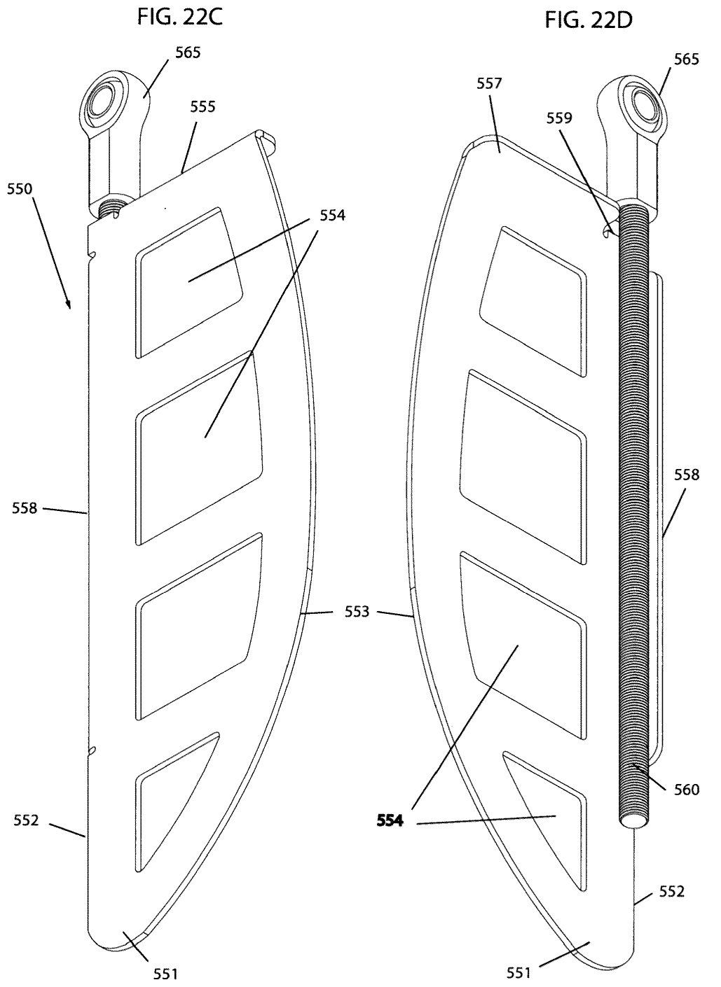

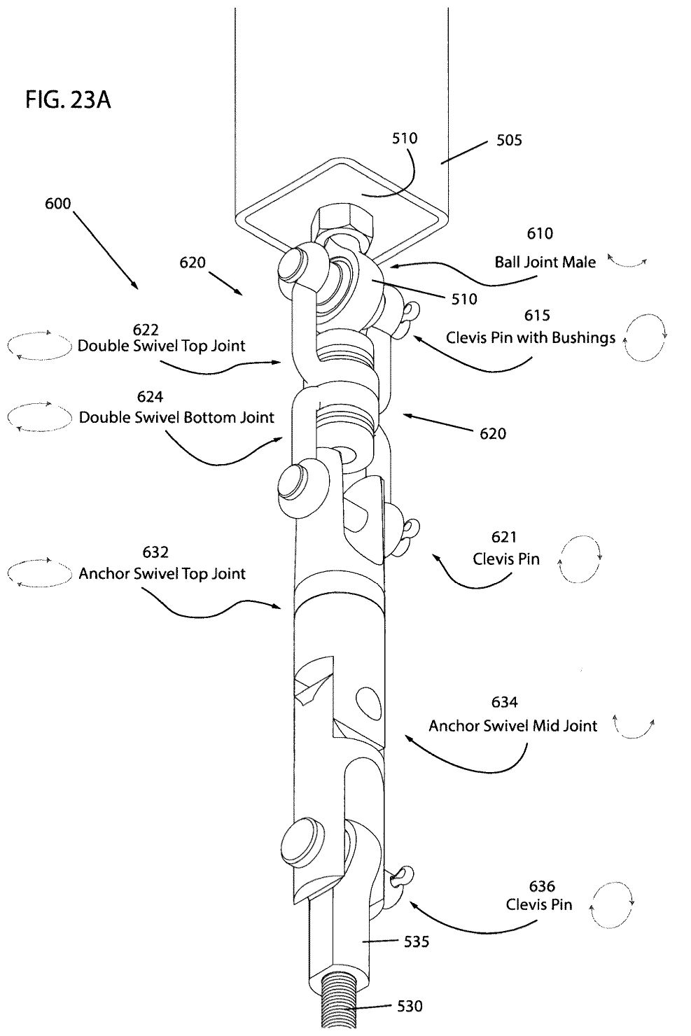

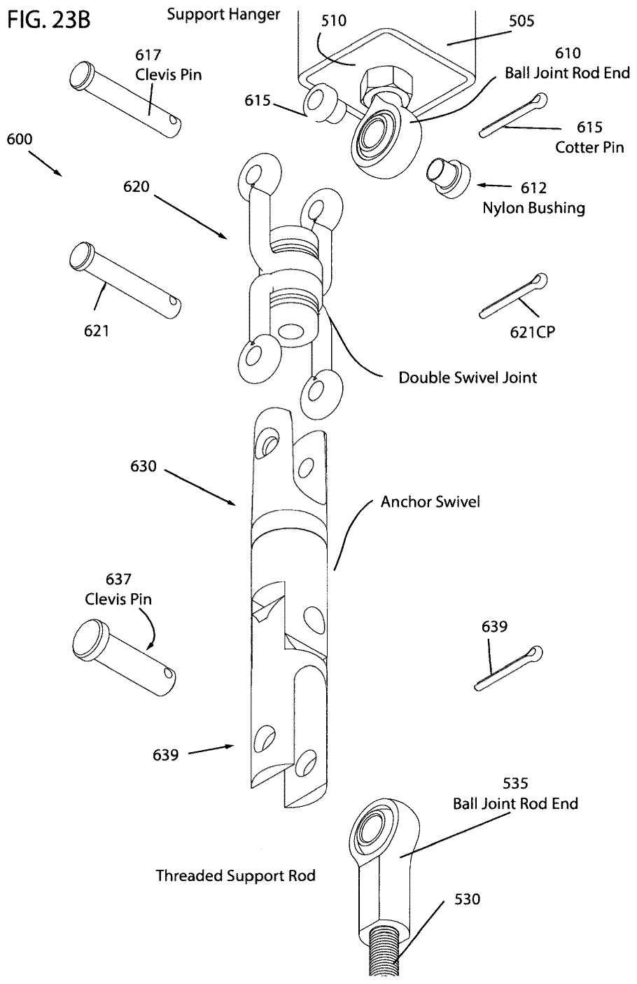

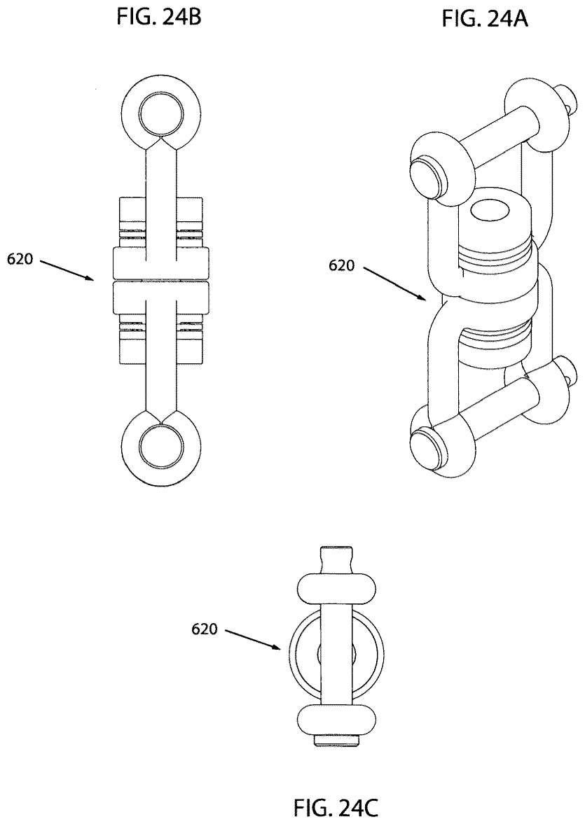

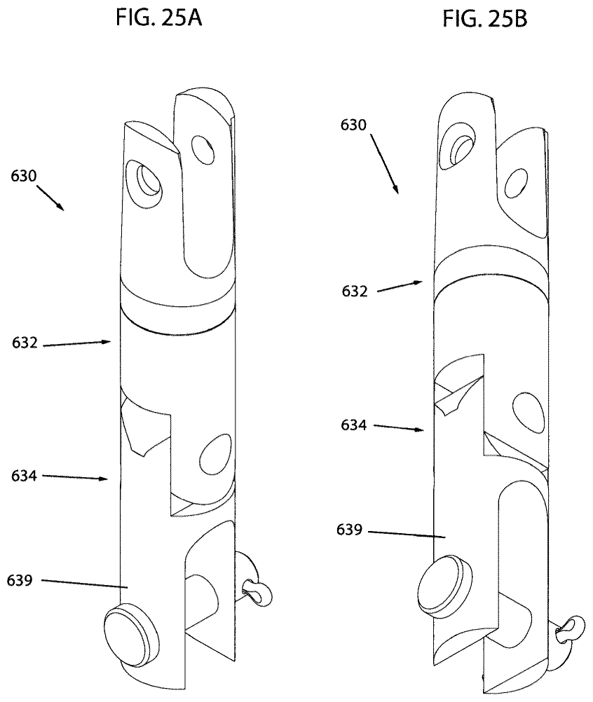

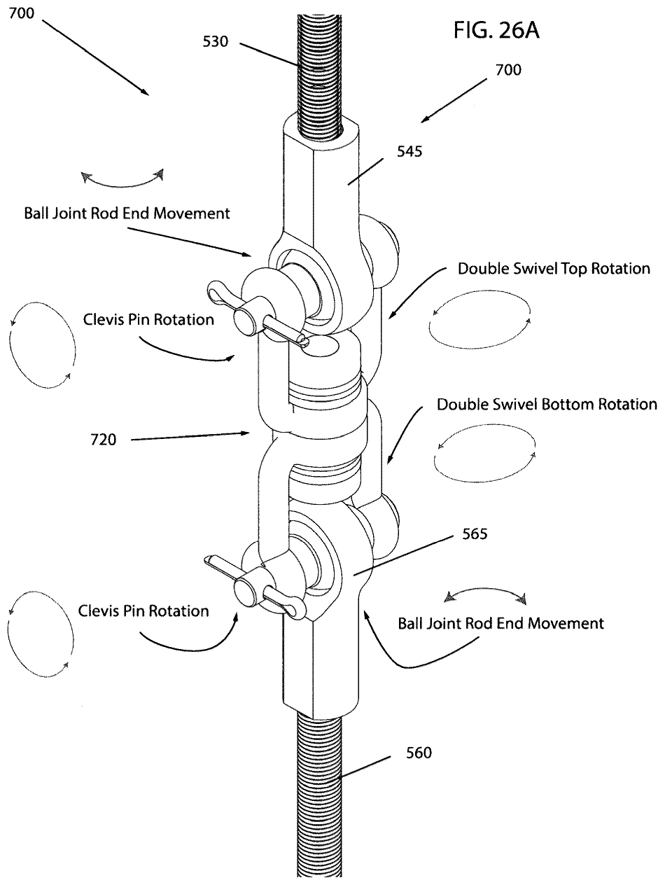

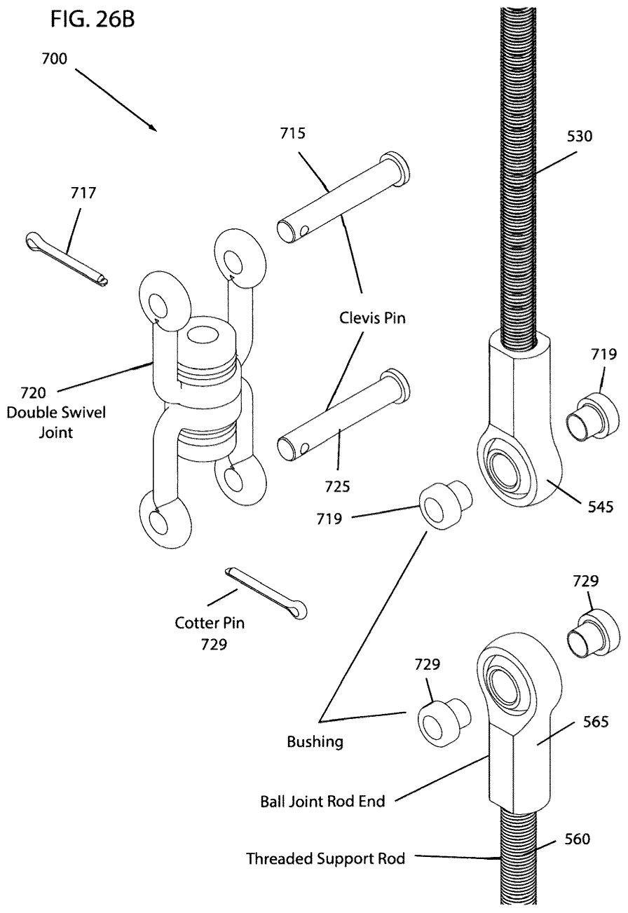

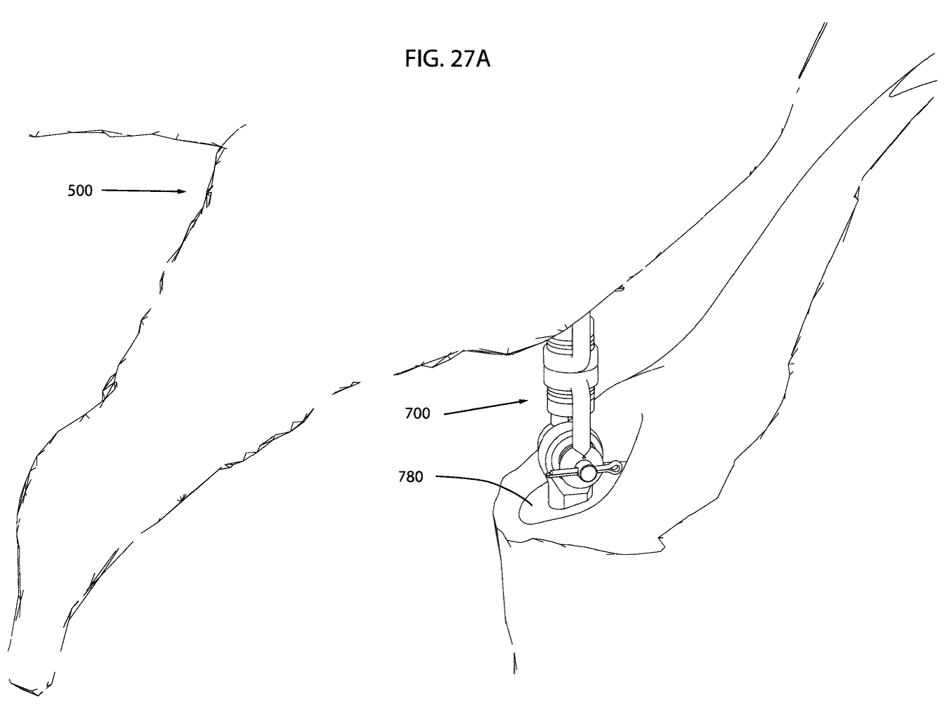

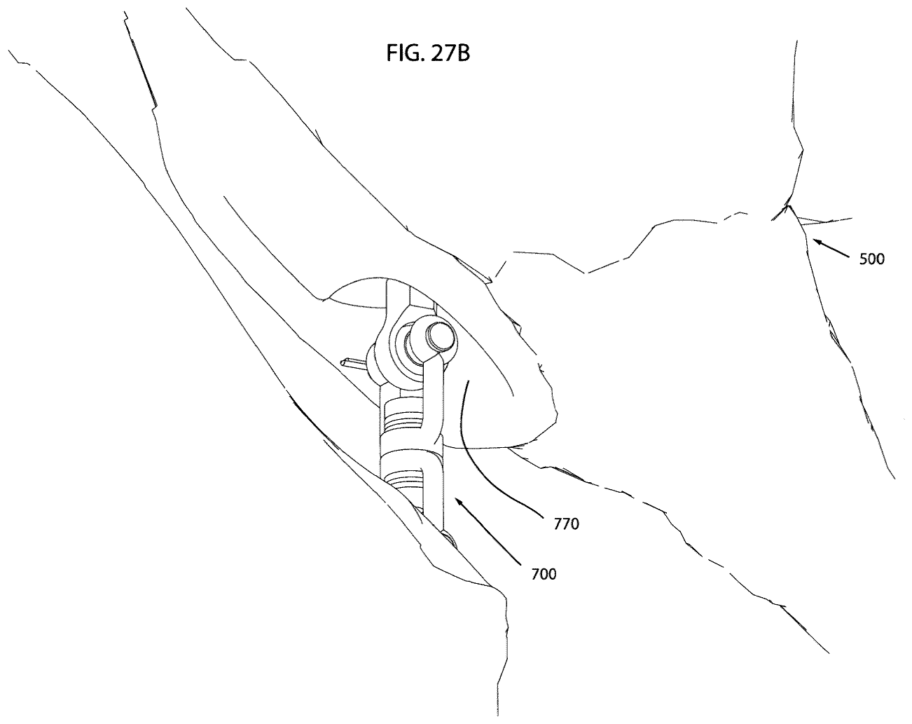

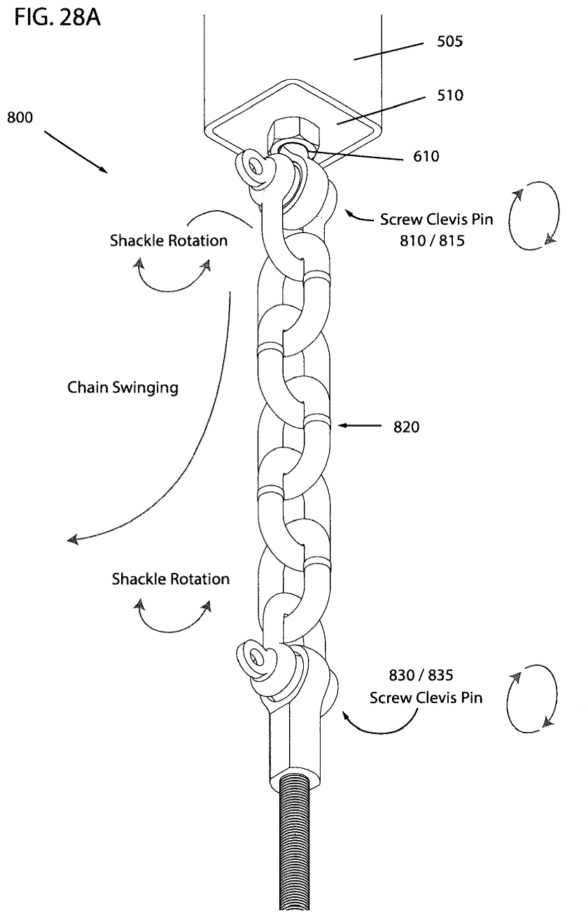

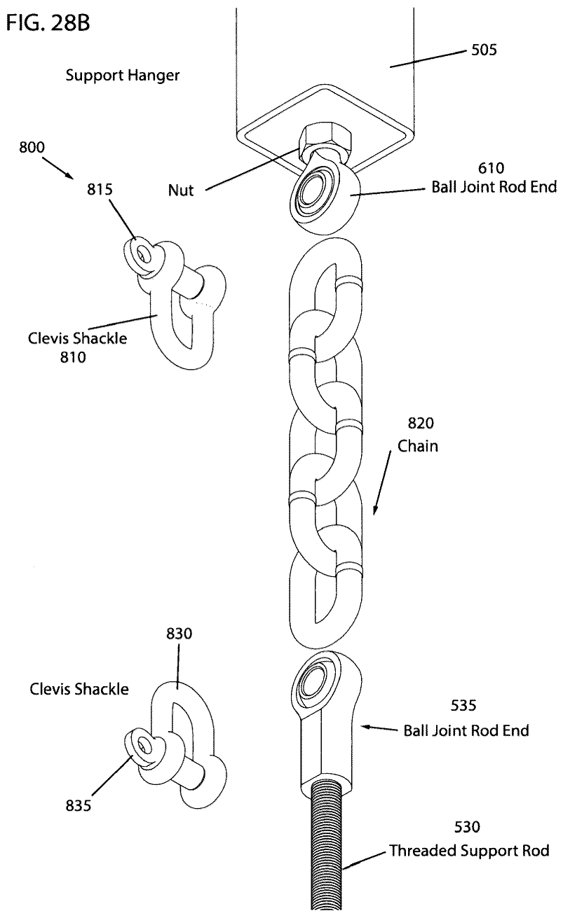

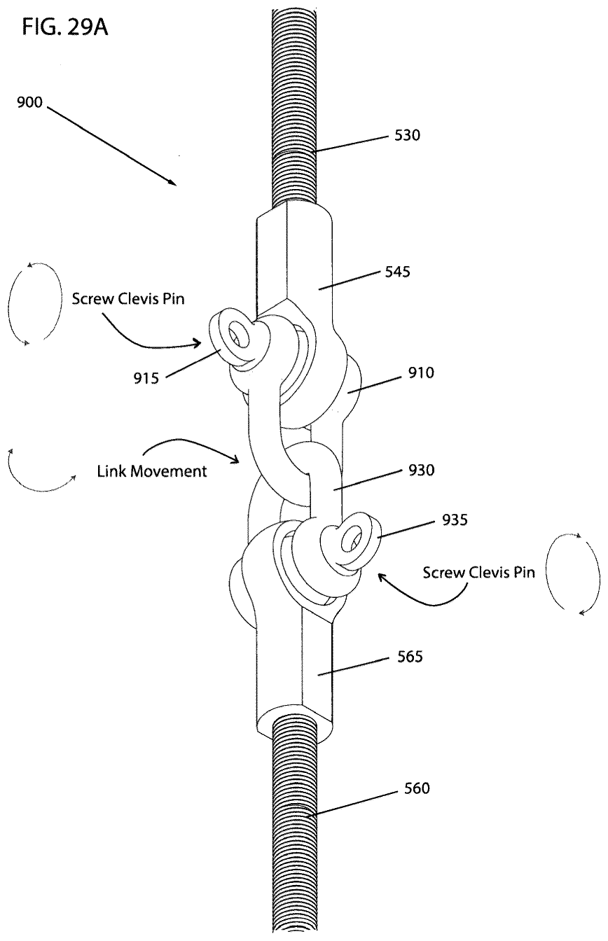

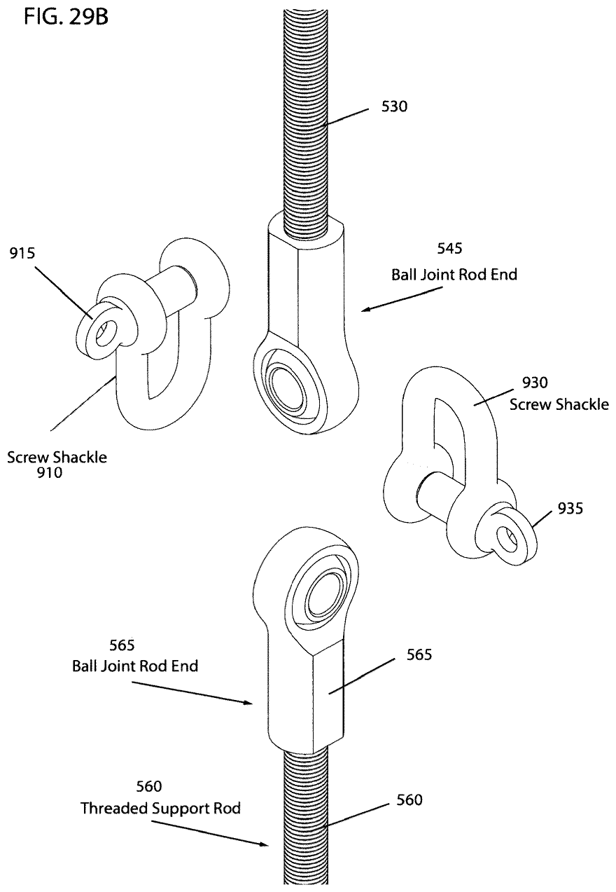

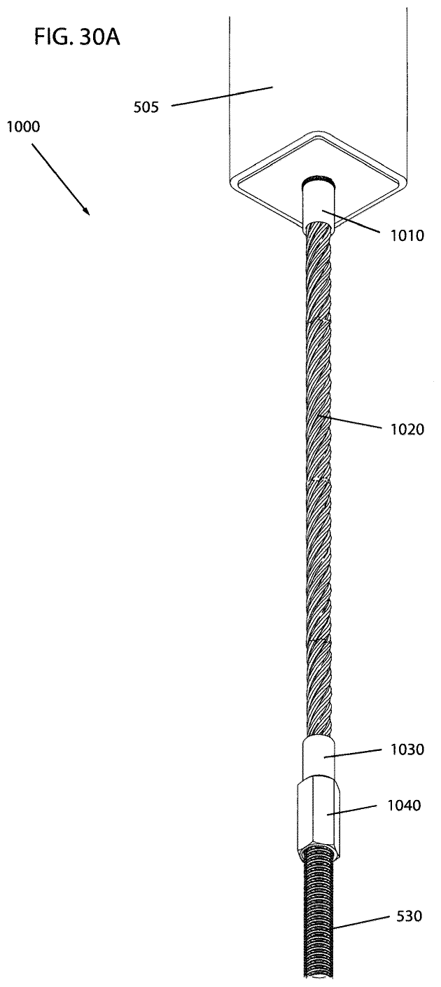

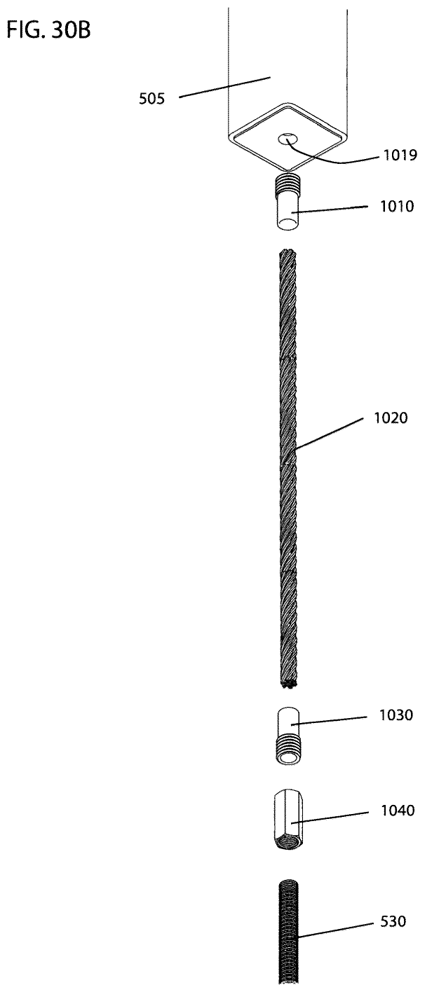

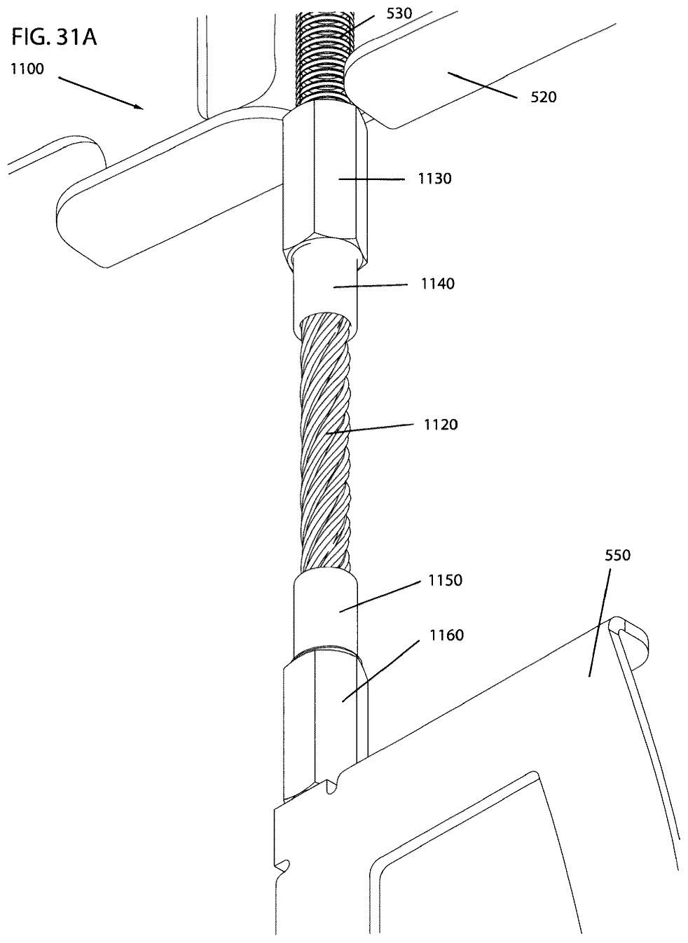

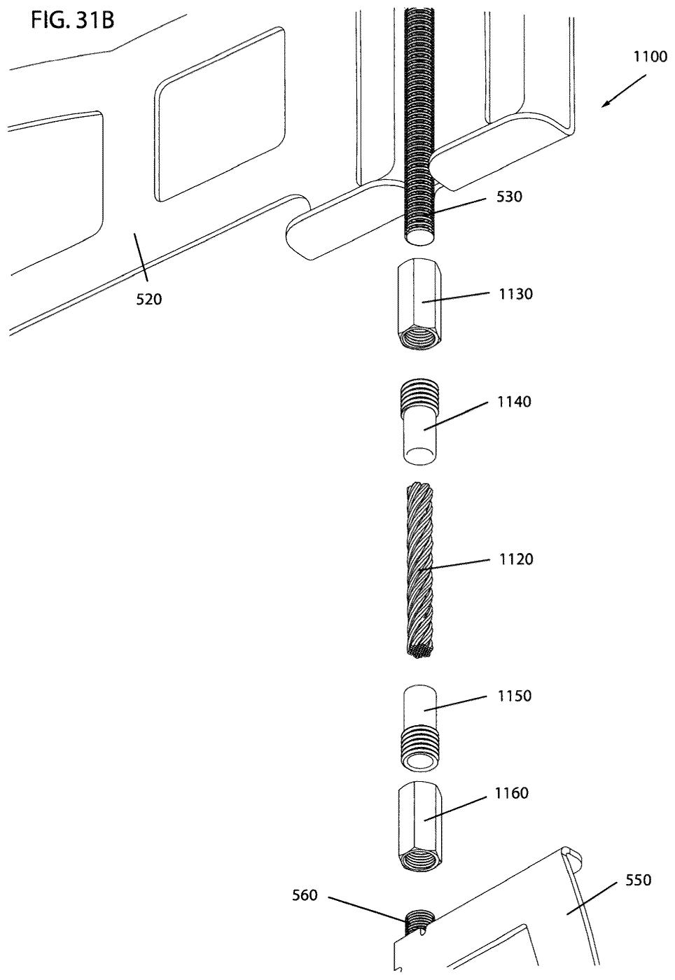

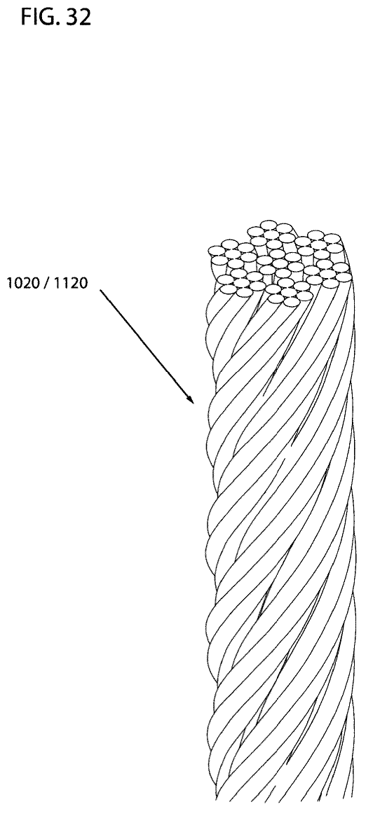

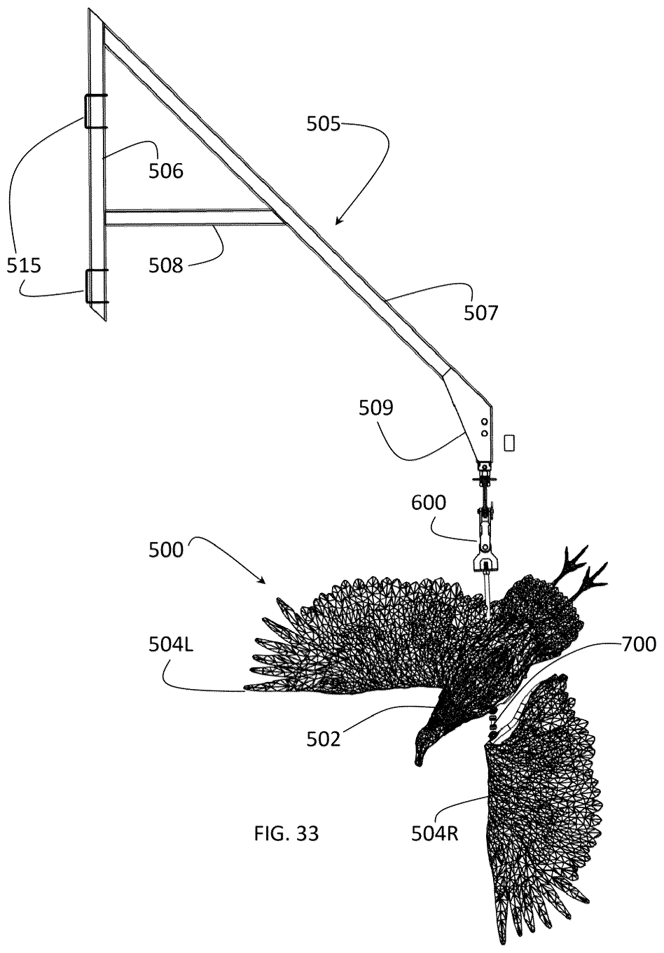

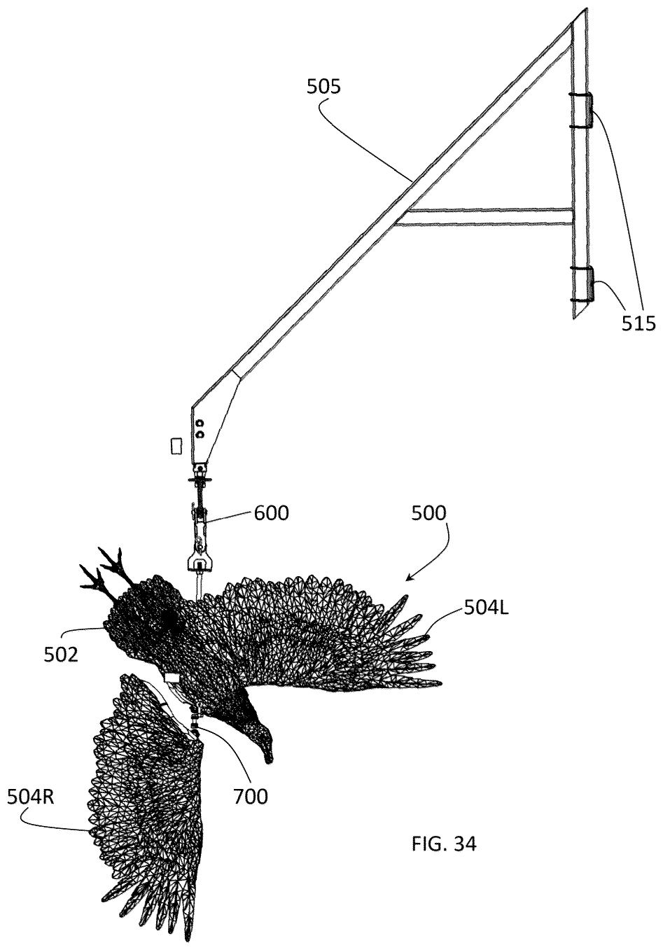

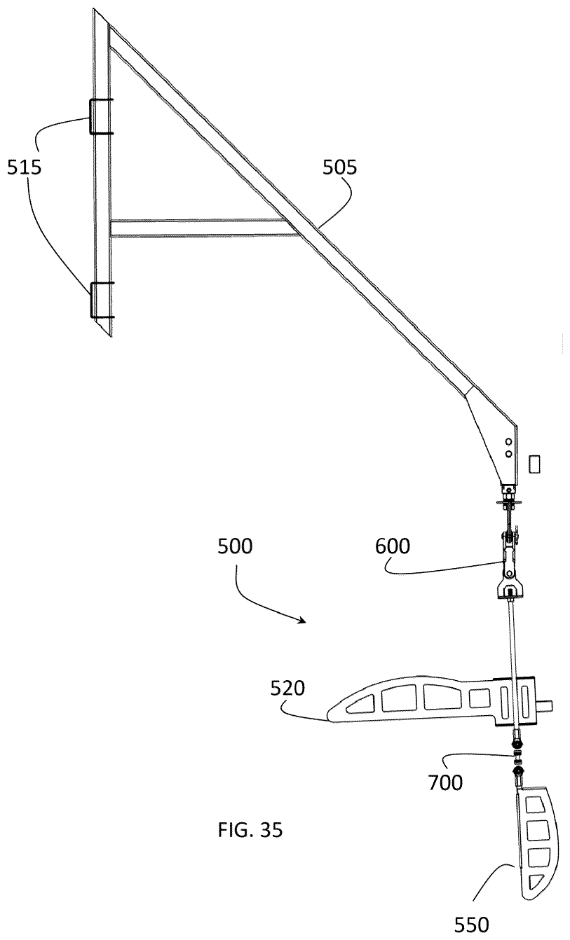

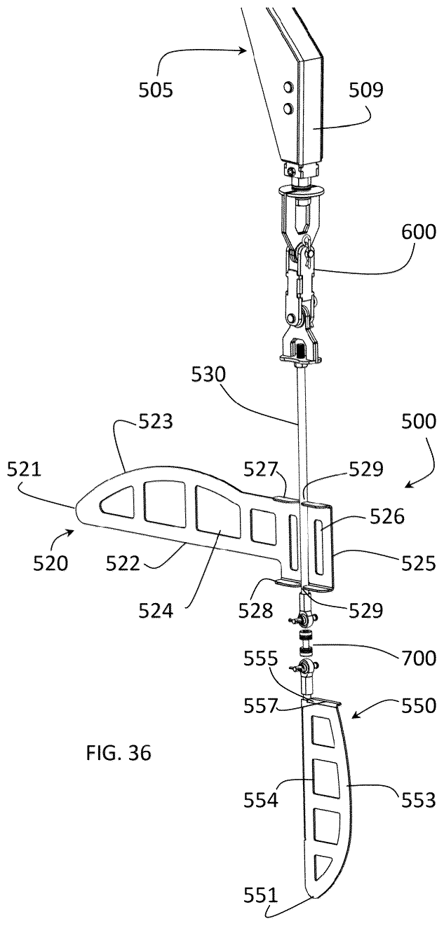

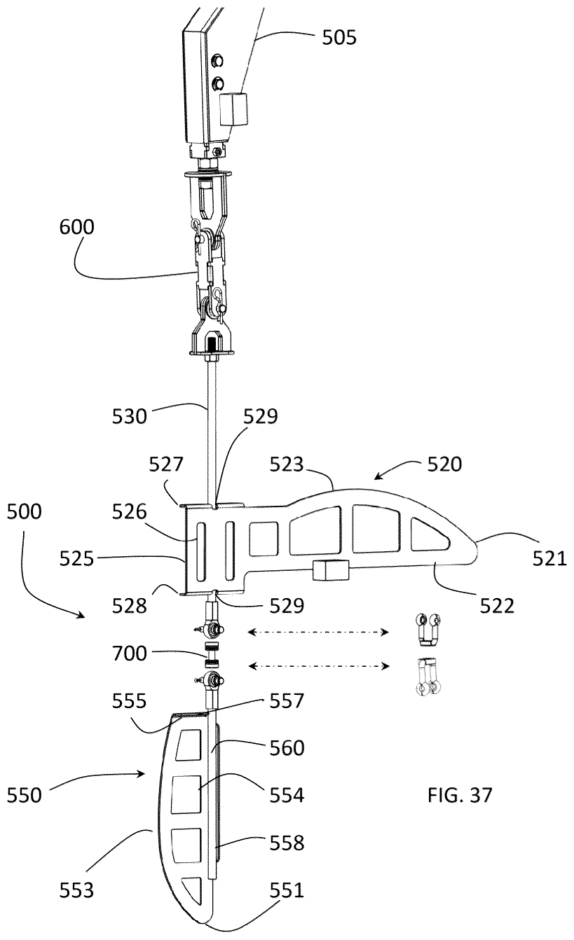

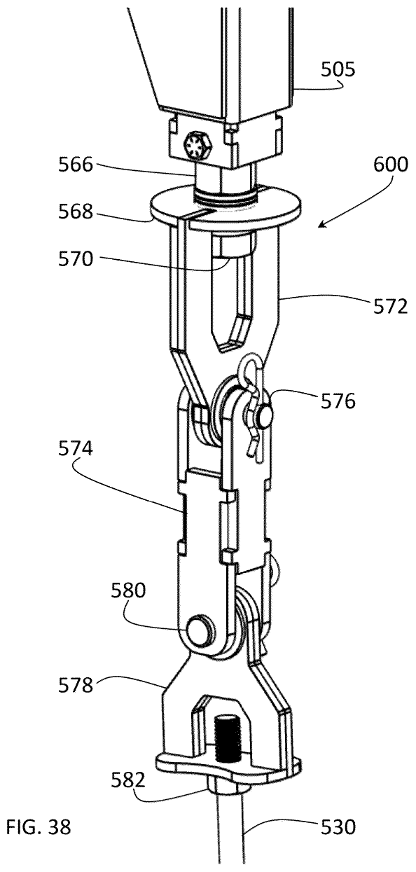

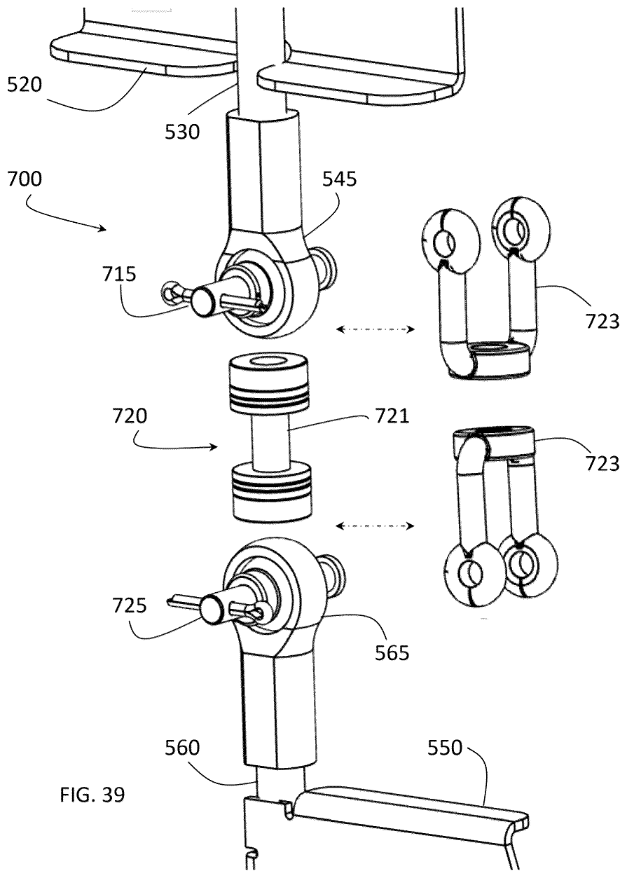

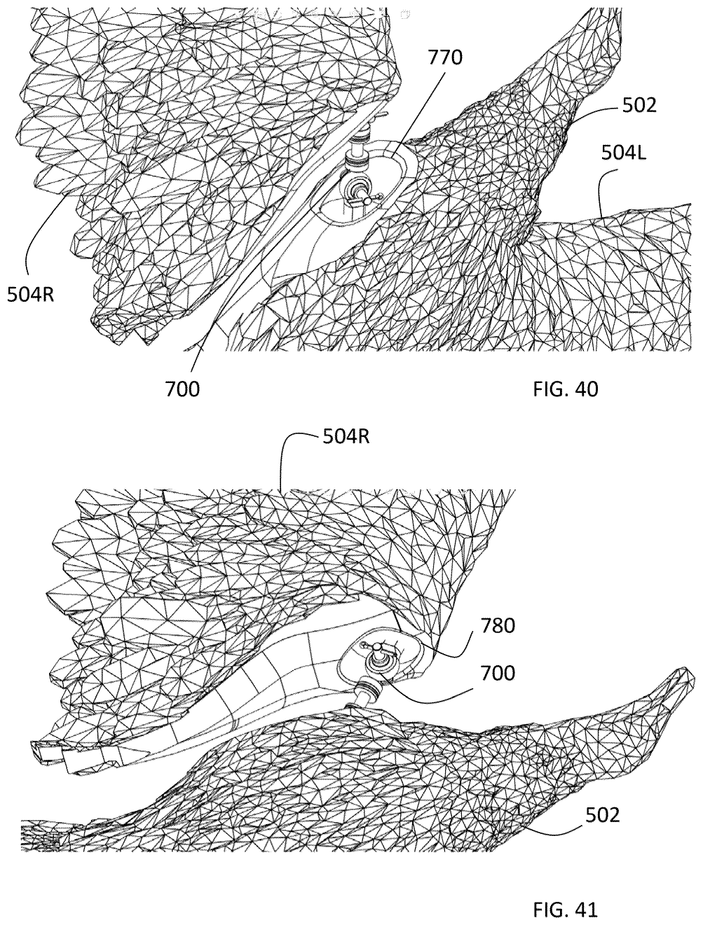

FIG. 15A is another front ahead view of the stand support 300 for a moveable bird effigy replica embodiment of FIG. 12A with the effigy 400 head end lowered. FIG. 15B is a cross-sectional view of the stand support 300 for a moveable bird effigy replica embodiment of FIG. 15A taken along line 15B-15B. FIG. 15C is a left side view of the of the stand support 300 for a moveable bird effigy replica embodiment of FIG. 14B without the effigy 400. FIG. 16 is an enlarged exploded view of the components of the stand support 300 for a moveable bird effigy replica embodiment referenced in the previous figures without the effigy 400.

Referring to FIGS. 12A-16, this embodiment can include a vertical post 310 having an upper horizontal leg 312 that can be formed from metal such as but not limited to galvanized metal, stainless steel, or any other appropriate material. The vertical post 310 and the upper horizontal leg 312 can be formed as a single pipe with an upper bent portion. Alternatively, the vertical post 310 can be welded to the horizontal leg 312.

A ledge mounting armature metal plate 320 has a front bent edge 322, a rear bent edge 324, and a top plate portion 322. The horizontal leg 312 passes through holes in the front bent edge 322 and the rear bent edge 324 and be attached together by welding or otherwise. The armature metal plate 320 can be made from galvanized metal, stainless steel, or any other appropriate material.

Fixably attached to the upper surface of the top plate portion 322 of the armature plate 320 is a bottom swivel mount metal base plate 330. One or more bearings 335 separate the bottom swivel base plate 330 from an upper swivel mount metal base plate 338. Fixably attached to the top surface of the upper swivel mount metal base plate 338 is an effigy metal base 340. A rear facing rudder 348 is fixably attached to a back of both the metal base plate 338 and metal base 340. Extending upward from the effigy metal base 340 are a pair of metal effigy support legs 350 attached thereto. The upper ends of the support legs 350 pass through the support holes 363 in the effigy body armature plate and insert into the lower ends of hollow effigy vertical support rods 370.

The effigy body armature metal plate 360 is formed underneath or within the lower body part of the effigy 400, such as by being molded to the effigy 400 as described in the previous embodiment. The effigy body armature metal plate 360 has a tip portion 362 extending under a neck portion of the bird replica effigy 440, side wings 364 with bent wing edges 366 extending under wing portions of the bird effigy replica 440, and rear portion 369 extending under the tail portion of the bird replica effigy 400. Slots 365 in the armature plate 360 allow for bottom portions of the molded effigy 400 to better adhere together.

Inside a hollowed out portion 405 of effigy 440 is a horizontal axle 374 having rotatable ends which pass into openings 371 in inner side portions of effigy vertical support rods 370. Extending upward from the rotatable axle 374 is a rocker arm 372 having an upper end pivotally attached to upper ends 376 of front support posts 390. The bottom ends 392 of front support posts 390 is pivotally attached outer ends of horizontal slider arms 380. Elongated slots 383 along inner ends of horizontal slider arms 380 allow for the horizontal slider arms 380 to slide about rotatable effigy support axle 386. The rotatable effigy support axle 386 has outer ends pivotally attached to inner portions of upper ends of the effigy vertical support rods 370. The foregoing parts, plates, and other components can be crafted from any suitable material. For instance, components can be made of metal, such as but not limited to galvanized steel or stainless steel, plastic, or another material suitable to the present invention.

Referring to FIGS. 12A, 13A, 13B, 14A, 14B, 15A, 15B, 16 and 10, the vertical post 310 can be mounted to a support structure, such as a vertical support 272 on a tower 270, by any effective mechanism, such as but not limited to a pipe-to-pipe clamp mount 260. When mounted, wind pushing against one side of rudder 348 allows for the bird replica effigy 400 to rotate relative to the ledge portion of the horizontal leg 312 by the bearing or bearings 335 between upper swivel mount base plate 338 and bottom swivel base plate 330 on the armature plate 320 attached to the horizontal leg 312. The rudder 348 can thus function similar to a weather vane. This makes the bird replica effigy 400, such as an eagle or other bird of prey, appear alive.

Referring to FIGS. 12A-12C, 14A-14C, 15A-15C, and 16, wind pushing against a back of the bird replica effigy 400 causes the effigy head portion to pivot down. The upper ends of the front support posts 390 are mounted to an inner surface within a hollowed out inside head portion of the effigy 400. The effigy head portion can pivot downward by the bottom ends of front support posts 390 pivoting at 392 to outer ends of horizontal arms 380 while inner slots 383 slide about rotatable axle 383 which rotates relative to vertical support rods 370. The effigy head portion also pivots downward based on outer ends of front support posts 390 pivoting with the upper end of rocker arm 372, which has a lower end that rotates relative to rotatable axle 374. The rotatable axle 374 is also rotatably attached to vertical support rods 370.

### Broken Wing Effigy Embodiments

FIG. 17A is a front perspective view of a broken wing effigy 500 according to the present invention attached to a hanger 505 mounted to a left support of a support structure. FIG. 17B is another front perspective view of the broken wing effigy 500 attached to the hanger 505 mounted to a left support of a support structure. FIG. 18A is a front perspective view of the broken wing effigy 500 attached to the hanger 505 mounted to a right support of a support structure. FIG. 18B is a further front perspective view of the broken wing effigy 500 attached to the hanger 505 mounted to a right support of a support structure. Thus, the broken wing effigy 500 can be mounted, such as by anchors 515 or in any other manner, to a support structure, such as but not limited to a tower or other structure as previously shown and described. The anchors 515 can include, but are not limited to brackets, bolts, other fasteners, and the like, such as those previously described.

FIG. 19A is an upper front perspective view of a bird armature plate 520 with a hanging linkage connection 600 and a wing linkage connection 700 with a wing armature plate 550 as are partially or completely embedded within the broken wing effigy 500 of FIGS. 17A-18B. FIG. 19B is another upper front perspective view of the bird armature plate 520 with the hanging linkage connection 600 and the wing linkage connection 700 with the wing armature plate 550 as are partially or completely embedded within the broken wing effigy 500 of FIGS. 17A-18B. Further, FIG. 19C is an upper rear perspective view of the bird armature plate 520 with the hanging linkage connection 600 and the wing linkage connection 700 with wing armature plate 550 as are partially or completely embedded within the broken wing effigy 500 of FIGS. 17A-18B. Still further, FIG. 19D is another upper rear perspective view of the bird armature plate 520 with the hanging linkage connection 600 and the wing linkage connection 700 with the wing armature plate 550 as are embedded partially or completely within the broken wing effigy 500 of FIGS. 17A-18B. Yet further, FIG. 19E is a front perspective view depicting the broken wing effigy 500 of FIG. 17A with the bird armature plate 520 with hanging linkage connection 600 and the wing linkage connection 700 with wing armature plate 550 positioned adjacent to the broken wing effigy 500 attached to a hanger 505 mounted to a left support.

FIG. 20A is a front view of the bird armature plate 520 with hanging linkage connection 600 and the wing linkage connection 700 with wing armature plate 550 of FIGS. 19A-19B, and FIG. 20B is a rear view of the bird armature plate 520 with hanging linkage connection 600 and the wing linkage connection 700 with wing armature plate 550 of FIGS. 19A-19B. Further, FIG. 20C is a left end view of the bird armature plate 520 with hanging linkage connection 600 and the wing linkage connection 700 with wing armature plate 550 of FIGS. 20A-20B. Further still, FIG. 20D is a right end view of the bird armature plate 520 with hanging linkage connection 600 and the wing linkage connection 700 with wing armature plate 550 of FIGS. 20A-20B. Additionally, FIG. 20E is a top view of the bird armature plate 520 with hanging linkage connection 600 and the wing linkage connection 700 with wing armature plate 550 of FIGS. 20A-20B while FIG. 20F is a bottom view of the bird armature plate 520 with hanging linkage connection 600 and the wing linkage connection 700 with wing armature plate 550 of FIGS. 20A-20B.

### Bird Body Armature Plate 520

FIG. 21A is an upper front perspective view of the bird armature plate 520 with threaded rod 530 used in FIGS. 19A-20E. FIG. 21B is an upper rear perspective view of the bird armature plate 520 with threaded rod 530 of FIG. 21A. FIG. 21C is a lower front perspective view of the bird armature plate 520 with threaded rod 530 of FIG. 21A, and FIG. 21D is a lower rear perspective view of the bird armature plate 520 with threaded rod 530 of FIG. 21A.

Referring to FIGS. 20A-21D, the bird armature plate 520 can be formed from metal, such as but not limited to galvanized metal or stainless steel, or any other appropriate material. The bird armature plate 520 has a narrow nose shaped front end 521 and a generally rectangular rear end 525. Along the top of bird armature plate 520 from the front end 521 to the start of the rear end 526 is a curved convex curved surface 523. Along the bottom of the bird armature plate 520 is a flat bottom edge 522 running from the front end 521 to the rear end 526. A plurality of oblong openings 524 extend through the side walls of the bird armature plate 520 between the front end 521 and the rear end 526. The generally rectangular rear end 525 has top bent edges 527 with a slot 529 therebetween and bottom bent edges 528 with a slot 529 therebetween. A pair of parallel vertical openings 526 pass through front and rear sides of the bird armature plate 520.

A threaded rod 530 having an upper end with a top ball point rod end 535 and a bottom ball point rod end 545 is oriented in a vertical position by the slots 529 between top bent edges 527 and bottom bent edges 528. The threaded rod 530 can be formed from metal, such as but not limited to galvanized metal or stainless steel, or any other appropriate material.

With the bird armature plate 520 and the threaded rod 530 so formed and connected, the main bird body part of the effigy 500 can be formed, such as by being molded, to encase the bird armature plate 520 and the threaded rod 530 in a similar manner to the previous embodiments.

### Wing Armature Plate 550

FIG. 22A is an upper front perspective view of the wing armature plate 550 with threaded rod 560 of FIGS. 19A-20E. FIG. 22B is an upper rear perspective view of the wing armature plate 550 with threaded rod 560 of FIG. 22A, and FIG. 22C is a lower front perspective view of the wing armature plate 550 with threaded rod 560 of FIG. 22A. Further, FIG. 22D is a lower rear perspective view of the wing armature plate 550 with threaded rod 560 in FIG. 22A.

As in FIGS. 22A-22D, for instance, the wing armature plate 550 includes a narrow rounded front end 551 with a convex curved top edge 553 that runs to a rear end 555 and a flat bottom edge 557 therebetween. A plurality of oblong openings 554 run from one side to the opposite side through the wing armature plate 550. A portion of the bottom edge 552 has a bottom bent edge 558, and a portion of the rear end 555 has a bent rear edge 557. A slot 55 formed where the rear bent edge 557 meets an upper end of the bottom bent edge 558 supports a threaded rod 560 in a vertical orientation. A top ball joint 565 is attached to the top of the threaded rod 560. The wing armature plate 550 and the threaded rod 560 can, for instance, be made from metal, such as but not limited to galvanized metal or stainless steel or any other appropriate material.

The wing portion of the effigy 500 can be formed by being molded curable material to encase the wing armature plate 55 and threaded rod 560 partially or entirely in a similar manner to the previous embodiments.

### Hanging Linkage Connection 600

FIG. 23A is a perspective view of the hanging linkage connection 600 between the hanger 505 and the threaded rod connection point 535, 530 of the bird body part of the broken wing effigy 500 of FIGS. 19A-19E, and FIG. 23B is an exploded view of the hanging linkage connection 600 between the hanger 505 and the threaded rod connection point 535, 530 of the bird body part of the broken wing effigy 500 of FIG. 23A. Further still, FIG. 24A depicts the double swivel top linkage 620 of FIGS. 23A-23B in a perspective view while FIG. 24B is a front view of the double swivel top linkage 620 of FIG. 24A. Additionally, FIG. 24C is a top view of the double swivel top linkage 620 of FIG. 24A.

FIG. 25A is an upper front perspective view of the anchor swivel linkage 630 of FIGS. 23A-23B, and FIG. 25B is a lower front perspective view of the anchor swivel linkage 630 of FIGS. 23A-23B.

As shown in FIGS. 19E-21D, the hanging linkage connection 600 includes a first plurality of linkages between the male ball joint 610 on the bottom 51 of the hanger 500 and between the top ball point rod end 535 on the threaded rod 530. The hanging linkage connection 600 includes the top prongs of a double swivel linkage 62 rotatably attached to the ball joint rod end 610 by a clevis pin 617 passing through opposite facing nylon type bushings 612 and held in place by a cotter pin 615. The bottom prongs of the double swivel linkage 620 is rotatably attached to the upper prongs of an anchor swivel linkage 630 by a clevis pin 621 held in place by another cotter pin 621CP. Further, the anchor swivel linkage 630 includes lower end prongs 639 which can be rotatably attached to a ball joint rod end 635 on top of threaded rod 530 by a clevis pin 637 held in place by a cotter pin 639.

Referring to FIG. 23A, the hanging linkage connection 600 allows for a plurality of rotation points as shown by the curved arrows at the ball joint male 610, the clevis pin with bushings 612, the double swivel top joint 622, the double swivel bottom joint 624, at clevis pin 621, the anchor swivel top joint 632, the anchor swivel mid joint 634, and the clevis pin 636.

The rotation points in the hanging linkage connection 600 allow for the main bird body part of the broken wing effigy 500 to move, swing, and swivel with the wind easily with up to eight or more points of rotation. The linkages in the hanging linkage connection 600 can be made from metal, such as but not limited to galvanized metal or stainless steel, or any other suitable material.

### Wing Linkage Connection 700

FIG. 26A is a perspective view of the wing linkage connection 700 between the threaded rod connection point of the bird body part with the threaded rod attached to the wing armature plate of FIGS. 19A-19E, and FIG. 26B is an exploded view of the wing linkage connection between the threaded rod connection point of the bird body part with the threaded rod attached to the wing armature plate of FIG. 26A.

Referring to FIGS. 19E-20D, 22A, 22B and 26A-26B, the wing linkage connection 700 includes a double swivel linkage 720 similar to the double swivel linkage 620 previously described. The upper prongs of the double swivel linkage 720 are rotatably attached to the bottom ball joint rod end 545 of the threaded rod 530 with bushings 719 and clevis pin 715 held in place by a cotter pin 715. The bottom prongs of the double swivel linkage 720 are rotatably attached to the top ball joint 565 on the threaded rod 560 with bushings 729 and clevis pin 725 held in place by cotter pin 729. The rotation points in the wing linkage connection 700 allow the wing part of the broken wing effigy 500 to move, swing, and swivel with the wind easily over up to six or more points of rotation. The linkages in the hanging linkage connection 700 can be made from metal, such as but not limited to galvanized metal or stainless steel, or any other appropriate material.

FIG. 27A is an enlarged view showing the wing pocket 780 in the wing part of the broken wing effigy 500 for the wing linkage connection 700 shown in FIGS. 17A-18B, and FIG. 27B is an enlarged view of the bird pocket 770 in the bird part of the broken wing effigy 500 for the wing linkage connection 700 shown in FIGS. 17A-18B and 27A.

Referring to FIGS. 19E and 27A-27B, plastic cup-shaped pockets 770 and 780 are located in the broken wing effigy 500, such as in the sides of the main bird part and in the wing part of the broken wing effigy 500. The pockets 770 and 780 in the broken wing effigy 500 allow for the wing part and the main bird part to be physically spaced close to one another. In certain practices, plastic cups or similarly shaped structures can be located inside the molds as the main bird body and wing part of the effigy 500 are separately formed. The pockets 770 and 780 allow for ends of the linkages in the wing linkage connection 700 to be partially counter-sunk into the molded main bird body and partially counter-sunk into the molded wing. The pockets 770 and 780 allow for the wing part and the main bird part of the effigy 500 to be drawn close together, such as to within inches of each other.

While some bushings have been shown and described, any metal-to-metal connect areas can also include additional bushings as needed. Bushings can include, but are not limited to, those formed from nylon, nylon composites, elastomeric materials, composites, and other materials.

### Chain Connection Embodiment

FIG. 28A provides a perspective view of an alternative hanging linkage connection 800 between the hanger 505 and the threaded rod connection point 830/835 of the bird body part of the broken wing effigy 500 of FIGS. 19A-19E with chain links. FIG. 28B is an exploded view of the alternative hanging linkage 800 of FIG. 28A.

Referring to FIGS. 19E, 28A, and 28B, the alternative hanging linkage connection 800 includes the locking pin 815 of a top clevis shackle 810 rotatably attached to the ball joint 610 attached to the hanger 505. The top clevis shackle 810 is attached to an upper link of a metal chain 820. The lower end of the metal chain 820 is attached to a bottom clevis shackle 830, and the locking pin 835 of the bottom clevis shackle 830 is rotatably attached to the ball joint rod end 535 of the threaded support rod 530 for the bird armature plate 520. The alternative hanging linkage connection 800 can also allow the broken wing effigy 500 to move, sway and rotate in the wind similar to the previous embodiment.

FIG. 29A is a perspective view of an alternative wing linkage connection 900 between the threaded rod connection point 545 of the bird body part with the threaded rod 530 attached to the wing armature plate 520 of FIGS. 19A-19E with single chain type link 900. FIG. 29B is an exploded view of the alternative wing linkage 900 of FIG. 29A.

As illustrated in FIGS. 19E and 29A-29B, the alternative wing linkage connection 900 also allows the molded wing part of the broken wing effigy 500 to sway and rotate in the wind similar to the previous embodiment.

### Cable Connection Embodiment

FIG. 30A is a perspective assembled view of another alternative hanger-to-bird-body connection 1000, and FIG. 30B is an exploded perspective view of the alternative hanger-to-bird-body connection 1000 of FIG. 30A.

FIG. 31A is a perspective assembled view of an alternative bird body to wing connection 1100, and FIG. 31 B is an exploded perspective view of the alternative bird body to wing connection 1100 of FIG. 31A.

Further, FIG. 32 is a perspective cross-sectional view of 7×7 cables 1020/1120 that can be used in the alternative connections shown in FIGS. 31A and 31B. Cables 1020/1120 can include, but are not limited to an aircraft galvanized steel cable wire rope, 1/16″, 7×7, constructed of 7 outer strands of 7 wires per strand that can be twisted, such as that manufactured by ALEKO® products of Kent, Washington.

Referring to FIGS. 19E, 30A, 30B, and 32, a 7×7 steel cable 1020 having an upper end with a coupler 1020 that is compression fitted and an upper threaded end that is attached into a threaded socket 1019 in the hanger 505. The bottom of the cable 1020 is attached to a compression coupler 1030 having a lower threaded end that threads into an upper threaded socket of a coupler 1040. The bottom of the coupler 1040 can have a threaded socket that fits over the threaded end of threaded rod 530 that is attached to bird armature plate 510 as previously described.

Referring to FIGS. 19E and 31A, 31B, and 32, a steel cable 1120 having an upper end attached to a compression coupler 1140, which has an upper threaded end, inserts into a lower threaded socket of a coupler 1130. The coupler 1130 has an upper threaded socket that is attached about the lower threaded end of threaded rod 530. The bottom of cable 1120 is attached to a compression coupler 1150, which has a lower threaded end that can be attached to an upper threaded socket of coupler 1160. The coupler 1160 has a lower threaded socket that attaches about the threaded rod 560 that is attached to wing armature 550 as previously described. Other couplers, such as but not limited to swivel linkages, including as previously described, can be included with the cable embodiments.

Within the scope of the invention, bird effigies can cover bird types other than those shown and described. By way of example and not limitation, the types of effigies can include, but are not limited to, vultures, turkeys, crows, grackles, seagulls, cranes, osprey, hawks, and still further effigy types.

A further embodiment of the broken wing bird effigy is again indicated generally at 500 in FIGS. 33 and 34. The bird effigy 500 has a main body 502 with an extended left wing 504L integrally formed therewith, such as by molding. As such, the left wing 504L is fixed in relation to the main body 502 of the bird effigy 500. In practice, the bird effigy 500 is suspended in a substantially upside-down orientation with the head of the main body 502 pointing downwardly, the torso of the main body 502 at a roughly 45-degree angle, and the feet extended upwardly giving a distressed, lifeless appearance. An extended right wing 504R is connected to the main body 500 by a wing linkage 700 that allows the right wing 504R to dangle lifelessly in relation to the main body 500.

The bird effigy 500 is suspended from a hanger 505 by a hanging linkage 600. In this embodiment, the hanger 505 comprises an A-shaped hanger 505 with a vertically-disposed base leg member 506, a retaining leg member 507 disposed at an acute angle relative to the base leg member 506, and a bracing member 508 horizontally disposed with a first end fixed to the base leg member 506 and a second end fixed to the retaining leg member 507. A support bracket 509 is retained at the distal end of the retaining leg member 507 for engaging and supporting the bird effigy 500 by engagement with the hanging linkage 600. The A-shaped hanger 505 has upper and lower mounting anchors 515 fixed to the base leg member 506 that enable the A-shaped hanger 505 and thus the bird effigy 500 to be mounted to a support structure (not shown in FIGS. 33 and 34), such as a cell or other communications tower as previously shown and described.

The present embodiment of the effigy 500 can be further understood with reference to FIGS. 35 through 37 where the molded main body 502 and left and right wings 504L and 504R are removed to permit illustration of the internal structures and interconnections forming the effigy. There, one can perceive that the main body 502 of the bird effigy 500 encases a bird armature plate 520 while the right wing 504R of the bird effigy 500 encases a wing armature plate 550. An elongate rod 530 has a proximal end retained by the hanging linkage 600 and a distal end that retains the wing linkage 700, and the body armature plate 520 is fixed, such as by welding or any other method, to the elongate rod 530 adjacent to the distal end thereof. Further, an elongate rod 560 has a proximal end retained by the wing linkage 700, and the wing armature plate 550 is fixed, such as by welding or any other method, to the elongate rod 560. In the present embodiment, the bird armature plate 520 has an elongate body that is disposed generally orthogonally to the elongate rod 530 while the wing armature plate 550 has an elongate body that is disposed generally collinearly with the elongate rod 560. Again, the body armature plate 520, the wing armature plate 550, and the elongate rods 530 and 560 can be crafted from any appropriate material, such as galvanized or stainless steel or any other suitable material.

As shown in FIG. 36, the bird armature plate 520 again has a flat body portion with a convex curved upper edge 523 and a straight lower edge 522 such that the bird armature plate 520 terminates in a narrow distal tip 521. The bird armature plate 520 has a substantially rectangular proximal end portion 525 with rigidifying upper and lower bent edges 527 and 528. A slot opening 529 is centrally disposed through the upper and lower bent edges 527 and 528 whereby the elongate rod 530 can be disposed in contact with the flat body portion of the bird armature plate 520.

Plural apertures 524 bounded by upper and lower edges matching the curved and straight upper and lower edges 523 and 522 respectively and vertically disposed lateral edges are spaced along the flat body portion of the bird armature plate 520, and parallel vertical slots 526 are disposed in the end portion 525 of the bird armature plate 520 with the elongate rod 530 traveling therebetween.

Under this construction, the bird armature plate 520 serves as the framework within the main body 502 of the effigy 500. Where the main body 502 is molded, such as from a curable material, the material of the main body 502 will pass through the apertures 524 and slots 526 in the bird armature plate 520 while the rigidifying upper and lower bent edges 527 and 528 project into the material of the main body 502. The apertures 524 and slots 526 thus form expanded open flow channels through the bird armature plate 520. The openings facilitate a more uniform and balanced distribution of the curable material, such as urethane foam or any other material suitable to the intended purpose, forming the main body 502 and left wing 504L during the molding and curing process thereby promoting improved material consistency, fewer voids, and increased strength of the resulting main body 502 and wing 504L structures. The main body 502 of the effigy 500 and the bird armature plate 520 are thus formed into a stable and durable unified structure.

As best seen in FIG. 37, the wing armature plate 550 is likewise founded on a flat body portion. The wing armature plate 550 has a convex curved outer edge 523 and a straight inner edge 522 such that the wing armature plate 550 terminates in a narrow distal tip 551. The wing armature plate 550 has a proximal end 555 with a rigidifying proximal bent edge 557. Further, a rigidifying bent longitudinal edge 558 is disposed to project from the inner edge 522 of the wing armature plate 550, and the elongate rod 560 is disposed to communicate longitudinally within the alcove defined by the flat body portion and the bent longitudinal edge 558 from the proximal end 555 to adjacent to the distal tip 551. Plural apertures 554 bounded by outer and inner edges matching the curved and straight outer and inner edges 523 and 522 respectively and horizontally disposed upper and lower edges are spaced along the flat body portion of the wing armature plate 550.

So constructed, the wing armature plate 550 serves as the framework within the right wing 504R of the effigy 500. Where the right wing 504R is molded, such as from a curable material, the material of the right wing 504R will pass through the apertures 554 in the wing armature plate 550 while the rigidifying proximal and longitudinal bent edges 557 and 558 project into the material of the right wing 504R. The apertures 554 thus form expanded open flow channels through the wing armature plate 550 thereby facilitating a more uniform and balanced distribution of the curable material forming the right wing 504R during molding and curing. Improved material consistency, fewer voids, and increased strength of the resulting main body 502 and wing 504L structures are thus achieved. The right wing 504R of the effigy 500 and the wing armature plate 550 are consequently formed into a stable and durable unified structure.

The hanging linkage 600 of the present embodiment can be better understood with reference to the amplified view of FIG. 38. There, one can perceive that the hanging linkage 600 is secured to the support bracket 509 of the hanger 505 by a retaining member 566 comprising a threaded rod and a fastening nut 570. The hanging linkage 600 has an upper end portion comprising an annular swivel plate 568 that is rotatably retained by the retaining member 566, which passes through a threaded central aperture in the swivel plate, and the fastening nut 570, which is threaded onto the retaining member 566. A U-shaped swivel member 572 is fixed to pivot with the swivel plate 568, and a first end of a central pivot member 574 is pivotally coupled to the base of the U shape of the U-shaped swivel member 572 by a clevis pin 576. A lower pivot member 578 with a central upper portion and a forked lower portion is pivotally coupled to a second end of the central pivot member 574 by a clevis pin 580 that passes through the second end of the central pivot member 574 and the central upper portion of the lower pivot member 578. Further, a base plate 584 is fixed to the forked lower portion of the lower pivot member 578. The base plate 584 can be considered to form a lower end portion of the hanging linkage 600. The proximal end of the elongate rod 530 onto which the main body 502 of the bird effigy 500 is formed is threadedly engaged with a threaded aperture in the base plate 584 and selectively locked in place by a threaded nut fastener 582 acting as a locking jam nut. The central pivot member 574 pivots relative to the swivel member 572 about a first pivot axis, and the lower pivot member 578 pivots relative to the central pivot member 574 above a second pivot axis that is orthogonal to the first pivot axis.

The components of the hanging linkage 600 can be formed from a material, such as but not limited to stainless or galvanized steel or another material, of high strength and that is suitable to exterior applications. Bearings are incorporated in the pivoting and rotating joints as necessary to provide smooth and unrestricted rotation and pivoting and thus natural movement of the bird effigy 500 in a realistically lifeless manner, which as noted herein is distressing to living birds that would otherwise present a nuisance to the tower and its surroundings.

In the present embodiment, the elongate rod 530 is of an increased diameter, such as of approximately ½ inch, with threading, such as at 20 threads-per-inch, disposed along the proximal and distal end portions thereof. The threading of the proximal end enables engagement and retention relative to the retaining member 566 and the fastening nut 570. The threading enables multiple attachment points for the elongate rod 530 and modular integration with ancillary components. For instance, the threading at the end portions of the elongate rod 530 can additionally enable engagement with an optional safety lanyard or tether (not shown). Moreover, the threading along the distal portion of the elongate rod 530 enables threaded engagement with the wing linkage 700 as further described hereinbelow.

As FIG. 38 depicts, the central pivot member 574 is formed with opposed upper pivot plates 575 disposed in a spaced, facing relationship and opposed lower pivot plates 577 disposed in a spaced, facing relationship. The upper pivot plates 575 are rotated by 90 degrees relative to the lower pivot plates 577 such that a structure with a rectangular cross section is formed. The clevis pin 576 passes through upper end portions of the upper pivot plates 575, and the clevis pin 580 passes through lower end portions of the lower pivot plates 577.

Lower portions of the upper pivot plates 575 adjustably overlap with upper portions of the lower pivot plates 577. Channels are formed in the overlapping portions of the pivot plates 575 and 577 with outwardly projecting teeth defining the ends of the channels. With that, the teeth of the upper pivot plates 575 can slide within the channels of the lower pivot plates 577, and the teeth of the lower pivot plates 577 can slide within the channels of the upper pivot plates 575 whereby the effective length of the central pivot member 574 can be selectively adjusted by the lengths of the channels in the upper and lower pivot plates 575 and 577. The relative positioning of the pivot plates 575 and 577 can be locked in place in any effective manner, including by welding, by fasteners, or by any other mechanism.

Under this construction, the hanging linkage 600 provides a strong, durable, and highly-flexible support connection between the bird effigy 500 and a hanger, such as the A-frame hanger 505, and ultimately between the bird effigy 500 and a support structure, such as a cell or other communications tower. By the rotatable relationship established by the swivel plate 568 relative to the retaining member 566, the elongate rod 530 and thus the bird effigy 500 retained thereby are freely rotatable about a longitudinal axis such that the effigy 500 can pivot, turn, and spin relative to the tower in an attention-attracting manner further accentuating its distressed or lifeless appearance. Further, by virtue of the upper and lower, perpendicularly-related, laterally-communicating pivot axes established by the pivoting connections between the central pivot member 574 and the swivel member 572 and the lower pivot member 578, multiple additional degrees of freedom are created to permit the bird effigy 500 to rock and sway freely in any direction in further simulation of a distressed or lifeless bird. The A-frame hanger 505 with a projecting retaining leg member 507 provides spacing from the support structure adequate to permit free swaying, turning, and other movement of the bird effigy 500 relative to the cell or other communications tower or other support structure.

Meanwhile, free, apparently lifeless independent movement of the right wing 504R relative to the main body 502 of the bird effigy 500 is permitted by the wing linkage 700, which is illustrated apart from the remainder of the effigy 500 and in partially-exploded form in FIG. 39. There, the wing linkage 700 can be seen to provide a highly durable and flexible connection between the wing armature plate 550 and thus the right wing 504R and the body armature plate 520 and thus the main body 502 of the bird effigy 500. A ball joint connector 545 is affixed, such as by a threaded relationship, welding, or in any other manner, to the distal end of the elongate rod 530 that communicates within the main body 502, and a ball joint connector 565 is affixed, again by a threaded relationship, welding, or in any other manner, to the proximal end of the elongate rod 560 that communicates within the right wing 504R. Each of the ball joint connectors 545 and 565 has a clevis pin, indicated at 715 and 725 respectively, that extends through the pivotable ball portion of the ball joint connector 545 or 565. A U-shaped swivel connector 723 has eye portions that receive the end portions of the clevis pin 715 of the ball joint connector 545 therethrough and an annular base portion that is rotatably engaged with a barbell-shaped coupling member 721. Similarly, a U-shaped swivel connector 723 has eye portions that receive the end portions of the clevis pin 725 of the ball joint connector 545 therethrough and an annular base portion that is rotatably engaged with the barbell-shaped coupling member 721.

A double swivel linkage 720 with multiple degrees of freedom is thus established to permit the right wing 504R not only to sway and pivot relative to the main body 502 of the bird effigy 500 but also to displace laterally in a manner unnatural to a healthy joint thus further simulating the injured, distressed, and lifeless appearance of the bird effigy 500. Where the components of the double swivel linkage 720 are formed from a high-strength, durable material, such as stainless or galvanized steel or another suitable material, a durable interconnection is established that can withstand the adversity of the exterior tower applications to which the bird effigy 500 is exposed. Bearings are incorporated in the pivoting and rotating joints as necessary to provide smooth and unrestricted rotation and pivoting and thus natural movement of the right wing 504R and the bird effigy 500 in general in a realistically lifeless manner, which as noted herein is distressing to living birds that would otherwise present a nuisance to the tower and its surroundings.

As FIGS. 40 and 41 illustrate, the present embodiment of the bird effigy 500 again incorporates a main body entrance pocket 770 formed in the material forming the main body 502 of the bird effigy 500. The main body entrance pocket 770 is centered around the elongate rod 530 and the wing linkage 700 with a depth and width sufficient to permit a realistic, close spacing of the right wing 504R relative to the main body 502 while also permitting free movement of the right wing 504R relative to the main body 502 and access to the countersunk distal end of the elongate rod 530 that is otherwise encased in the main body 502 of the bird effigy 500. In a similar manner, a wing entrance pocket 780 is formed in the material forming the right wing 504R of the bird effigy 500. The wing entrance pocket 780 is centered around the wing linkage 700 and the elongate rod 560 with a depth and width sufficient to permit a realistic, close spacing of the right wing 504R relative to the main body 502 while also permitting free movement of the right wing 504R relative to the main body 502 and access to the countersunk distal end of the elongate rod 560 that is otherwise encased in the right wing 504R of the bird effigy 500.

It will be understood that, although specific advantages of the invention disclosed herein have been enumerated above, certain embodiments of the effigy may be crafted to achieve fewer that all of the enumerated advantages while still remaining within the scope of the present invention. Modifications, additions, or omissions may be made to the systems, apparatuses, and methods described herein without departing from the scope of the invention. For example, components of the systems and apparatuses disclosed herein may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and the reader in interpreting the claims appended hereto, it is stated that the appended claims and claim elements are not intended to invoke 35 U.S.C. 112(f) unless the words “means for” or “step for” are explicitly used in the particular claim.

While the invention has been described, disclosed, illustrated and shown in terms of certain embodiments or modifications thereof, the scope of the invention is not intended to be, nor should it be deemed to be, limited thereby. Other modifications or embodiments as may be suggested or rendered obvious by the teachings herein are particularly reserved especially as they fall within the breadth and scope of the claims here appended.

I claim the following as deserving the protection of Letters Patent:

1. A bird effigy assembly comprising:
a bird effigy for being suspended from a support structure, the bird effigy comprising at least one armature and a main body and left and right wings formed to encase the at least one armature at least partially, wherein the main body and the left and right wings are simulative of the main body and left and right wings of a bird; and
a hanging linkage for suspending the bird effigy from the support structure, wherein the hanging linkage has a lower end coupled to the at least one armature of the bird effigy and an upper end portion configured to be coupled to the support structure, wherein the hanging linkage has at least one linkage connection that permits rotation of the at least one armature about a longitudinal axis of the hanging linkage, and wherein the hanging linkage has at least one linkage connection that permits pivoting about at least one lateral pivot axis within the hanging linkage.

2. The bird effigy assembly of claim 1, further comprising a hanger for suspending the bird effigy from the support structure.

3. The bird effigy assembly of claim 2, wherein the hanger comprises an A-shaped hanger with a base leg member for being affixed to the support structure, a retaining leg member disposed at an acute angle relative to the base leg member, and a support bracket fixed to a distal end of the retaining leg member.

4. The bird effigy assembly of claim 2, wherein the at least one linkage connection that permits rotation of the at least one armature about a longitudinal axis of the hanging linkage comprises a swivel plate configured to be rotatably retained by the hanger.

5. The bird effigy assembly of claim 4, further comprising a swivel member fixed to rotate with the swivel plate and wherein the linkage connection that permits pivoting about at least one lateral pivot axis within the hanging linkage comprises a central pivot member pivotally coupled to the swivel member to pivot about a laterally communicating first pivot axis.

6. The bird effigy assembly of claim 5, wherein the linkage connection that permits pivoting about at least one lateral pivot axis further comprises a lower pivot member pivotally coupled to the central pivot member to pivot about a laterally communicating second pivot axis.

7. The bird effigy assembly of claim 6, wherein the laterally communicating first pivot axis has a different orientation from the laterally communicating second pivot axis.

8. The bird effigy assembly of claim 7, wherein the laterally communicating first pivot axis is approximately orthogonal to the laterally communicating second pivot axis.

9. The bird effigy assembly of claim 5, wherein the central pivot member is selectively adjustable in effective length.

10. The bird effigy assembly of claim 9, wherein the central pivot member has opposed upper pivot plates disposed in a spaced, facing relationship and opposed lower pivot plates disposed in a spaced, facing relationship, wherein the upper and lower pivot plates are positioned rotated by 90 degrees relative to the lower pivot plates, wherein lower portions of the upper pivot plates adjustably overlap with upper portions of the lower pivot plates.

11. The bird effigy assembly of claim 10, wherein the upper pivot plates have channels therein, wherein the lower pivot plates have teeth that are configured to slide within the channels in the upper pivot plates, and wherein the teeth of the lower pivot plates can be adjusted in position by sliding within the channels in the upper pivot plates to adjust the effective length of the central pivot member.

12. The bird effigy assembly of claim 7, wherein the swivel member is U shaped and wherein a first end portion of the central pivot member is pivotally coupled to a base of the U shape of the swivel member.

13. The bird effigy assembly of claim 12, wherein the lower pivot member has a central upper portion and a forked lower portion, wherein the central upper portion of the lower pivot member is pivotally coupled to the central pivot member.

14. The bird effigy assembly of claim 13, further comprising a base plate fixed to the forked lower portion of the lower pivot member wherein the base plate forms the lower end of the hanging linkage and is coupled to the at least one armature of the bird effigy.

15. The bird effigy assembly of claim 14, wherein the at least one armature comprises a body armature plate and an elongate rod fixed to the body armature plate, wherein the body armature plate is at least partially encased by the main body of the bird effigy, wherein the elongate rod has a proximal end and a distal end, and wherein the proximal end of the elongate rod is retained by the base plate fixed to the forked lower portion of the lower pivot member.

16. The bird effigy assembly of claim 1, wherein the bird effigy comprises a body armature, a wing armature, and a wing linkage configured to connect the wing armature to the body armature.

17. The bird effigy assembly of claim 16, wherein the wing linkage has at least one linkage connection that permits pivoting of the wing armature relative to the body armature.

18. The bird effigy assembly of claim 17, wherein the wing linkage has upper and lower pivoting linkage connections that permit pivoting of the wing armature relative to the body armature at first and second pivoting locations.

19. The bird effigy assembly of claim 18, wherein the wing linkage has a first ball joint connector coupled to the body armature, a second ball joint connector coupled to the wing armature, and a swivel linkage interposed between the first and second ball joint connectors.

20. The bird effigy assembly of claim 19, wherein the swivel linkage comprises first and second U-shaped swivel connectors, wherein the first U-shaped swivel connector is pivotally coupled to the first ball joint connector, wherein the second U-shaped swivel connector is pivotally coupled to the second ball joint connector, and wherein the first and second U-shaped swivel connectors are rotatably retained by a coupling member interposed between the first and second U-shaped swivel connectors whereby a double swivel linkage is formed by the first and second U-shaped swivel connectors and the coupling member.

21. The bird effigy assembly of claim 20, wherein the main body is formed to encase the body armature at least partially, wherein one of the left and right wings is formed to encase the wing armature at least partially, wherein a main body entrance pocket is formed in the main body centered around the first ball joint connector, and wherein a wing entrance pocket is formed in the one of the left and right wings centered around the second ball joint connector.

22. The bird effigy assembly of claim 1, wherein the at least one armature comprises an armature plate with plural apertures through the armature plate and wherein material forming at least one of the main body, the left wing, and the right wing is configured to pass through the plural apertures through the armature plate.

23. The bird effigy assembly of claim 22, wherein the armature plate has at least one rigidifying bent edge disposed within the material forming the at least one of the main body, the left wing, and the right wing.

24. The bird effigy assembly of claim 23, wherein the main body, the left wing, and the right wing are formed from a curable material.
